(19) United States
(12) Patent Application Publication
(10) Pub. No.: US 2013/0106686 A1
(43) Pub. Date: May 2, 2013

(54) GESTURE PROCESSING FRAMEWORK

(71) Applicant: James D. Bennett, Hroznetin (CZ)

(72) Inventor: James D. Bennett, Hroznetin (CZ)

(73) Assignee: BROADCOM CORPORATION, IRVINE, CA (US)

(21) Appl. No.: 13/539,320

(22) Filed: Jun. 30, 2012

Related U.S. Application Data
(60) Provisional application No. 61/553,760, filed on Oct. 31, 2011.

(51) Int. Cl. G06F 3/01

(52) U.S. Cl. 345/156

(57) ABSTRACT

A gesture processing framework enables interaction between various devices, infrastructures, services, applications, and the like by mapping gesture input signals to control signals. Gesture input signals from various gesture input interfaces can be mapped to control various parts of a media environment by association with various control signals. The gesture processing framework can support a device interacting with one or more various media environments to map various gesture input signals, gesture maps, and the like with various control signals associated with the various media environments. Gesture inputs can be processed to identify one or more gesture input signals, and control signals associated with the gesture input signals can be sent in response to the identification. Identification of gesture input signals can include determining correlation within various levels of confidence. Interactions involving various entities can be managed to ensure proper processing of various input signals.

### CROSS REFERENCE TO RELATED PATENTS/PATENT APPLICATIONS

NOT APPLICABLE

### INCORPORATION BY REFERENCE

The following U.S. Utility patent applications are hereby incorporated herein by reference in their entirety and made part of the present U.S. Utility patent application for all purposes:

1. U.S. Provisional Patent Application Ser. No. 61/491,838, entitled “Media communications and signaling within wireless communication system,” (Attorney Docket No. BP22744), filed May 31, 2011, pending;

2. U.S. Provisional Patent Application Ser. No. 61/553,760, entitled “RF Based Portable Computing Architecture,” (Attorney Docket No. BP23019.1), filed Oct. 31, 2011, pending;

3. U.S. application Ser. No. 13/331,449, entitled “Bridged Control of Multiple Media Devices via a Selected User Interface in a Wireless Media Network,” (Attorney Docket No. BP22769), filed Dec. 20, 2011, pending;

4. U.S. application Ser. No. 13/342,301, entitled, “Social Network Device Memberships and Applications,” (Attorney Docket No. BP23771), filed Jan. 3, 2012, pending;

5. U.S. application Ser. No. 13/408,986, entitled, “Social Device Resource Management,” (Attorney Docket No. BP23776), filed Feb. 29, 2012, pending; and

6. U.S. application Ser. No. 13/337,495, entitled, “Advanced Content Hosting,” (Attorney Docket No. BP23823), filed Dec. 27, 2011, pending.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

1. Field of the Invention

This invention relates generally to media systems; and, more particularly, it relates to control of devices in a network via gesture input.

2. Related Art

Media environments often require several remote controls to carry out a desired media function, e.g., a first remote to turn on a TV and select a media input source, a second remote control to turn on and interact with a DVD player to initiate playback, and a third remote to interact with an AV receiver to control the audio presentation. To simplify control of multiple devices, CEC (Consumer Electronics Control) over HDMI (High-Definition Multimedia Interface) sets forth control signaling and procedures to help automate viewer interaction and minimize the number of remote control units needed. European SCART (Syndicat des Constructeurs d'Appareils Radiorécepteurs et Téléviseurs) standard offers similar functionality, such as enabling a remote control to send a “play” command directly to the DVD player. Upon receipt, the DVD player delivers control signaling that causes the AV receiver to power up, output further control signals to the TV, and produce AV output to speaker systems and the TV. The TV responds to such further control signals to power up, input the AV output, configure itself, and deliver the AV presentation.

In addition, media source devices can gather display capability information from an attached media device. Based on such information, a media source device can produce a media output that falls within such capabilities. Such capability information is typically stored and exchanged in data structures defined by industry standard, including, but not limited to, EDID (Extended Display Identification). Such a system can be less than optimal when a media source device and a media sink device have different media distribution demands and underlying pathway limitations.

Furthermore, some media devices can perform actions based upon gestures of a user. The gestures can be received as an input via a gesture input interface on a device, and the device can respond to receiving the gesture input by performing an action that is associated with the gesture. Such a media environment can be less than optimal when a media environment includes various devices with various input and output configurations.

### BRIEF DESCRIPTION OF THE DRAWINGS

FIG. 1 illustrates a schematic block diagram of a communication environment according to various embodiments;

FIG. 2 illustrates a schematic block diagram of a communication environment according to various embodiments;

FIG. 3 illustrates a schematic block diagram of a media environment according to various embodiments;

FIG. 4 illustrates a schematic block diagram of a media environment according to various embodiments;

FIG. 5 is a diagram illustrating a control signal association table according to various embodiments;

FIG. 6 is a diagram illustrating a gesture mapping table according to various embodiments;

FIG. 7 is a diagram illustrating a gesture macrosequence table according to various embodiments;

FIG. 8 illustrates a schematic block diagram of a media environment according to various embodiments;

FIG. 9 illustrates a flow diagram according to various embodiments;

FIG. 10 illustrates a flow diagram according to various embodiments;

FIG. 11 illustrates a flow diagram according to various embodiments;

FIG. 12 illustrates a flow diagram according to various embodiments;

FIG. 13 is a diagram illustrating transcoding of various input signals according to various embodiments;

FIG. 14 is a diagram illustrating transcoding of various input signals according to various embodiments;

FIG. 15 is a diagram illustrating a wireless communication system according to various embodiments; and

FIG. 16 is a diagram illustrating a wireless communication system according to various embodiments.

### DETAILED DESCRIPTION OF THE INVENTION

A novel system and architecture, referred to herein as a gesture processing framework, is presented herein by which one or more devices in various environments can be controlled by one or more selected gesture inputs, which can be mapped to signals, messages, or the like to or from one or more media devices.

A gesture processing framework can be supported (also referred to herein as “performed”, “implemented” and the like) by a processing circuitry, computing device, server device, application, service, etc. For example, the gesture processing framework can be supported, in part or in full, by processing circuitry included in a device interacting with a media environment. In another example, the gesture processing framework can be supported by a bridging element in a media environment that bridges interactions between various input devices, output devices, services, and applications. In some embodiments, the gesture processing framework is supported by a processing system that includes one or more instances of processing circuitry distributed in a media environment.

The term “gestures” as used herein include any motion of any part of a user's body (e.g., including limbs, body, fingers, toes, feet, head, etc.) and any motion of any physical elements held or worn by the user, wherein such motion is made by the user to control one or more local and/or remote devices, programs, network elements, etc. Such gesture motion may be associated with one or more of rotations, pointing, relative locations, positioning, forces, accelerations, velocities, pitch, yawn and other movement characteristics. Gesture motions may be rather simple with a single motion characteristic, or may be more complex with multiple varying motion characteristics over a longer period of time.

Gesture motion can be detected in many ways including, without limitation, detection using one or more of each of tactile sensors, image sensors, motion sensors, etc. That is, depending on the embodiment, multiple of any type of sensor along with multiple types of sensors can be utilized in concert to assist in gesture motion detection, capture, characterization, recognition, etc. For example, gesture motion can be captured via tactile interaction with one or more tactile sensing elements (e.g., a touch screen or an input pad). Such gesture motion is referred to herein as “tactile gesture motion.” Assisting in the capture process, motion and impact sensors might be employed. Alternatively (or in addition), visual imager arrays can be used to capture one or more images (e.g., a video frame sequence) associated with the gesture motion. Such gesture motion is referred to herein as “visual gesture motion.” All types of such sensors that work independently or in concert to capture gesture motion information can be placed within a single device or within a plurality of devices. Likewise, the characterization, processing, recognition, mapping, etc., of the gesture motion information may be housed within one or more of the user's devices. For example, a user's device can include a gesture input interface through which a user can provide input to the device by performing one or more various gestures. Upon gesture recognition, one or more commands can be issued to control either or both of the device and/or any other local or remote devices associated therewith.

A tactile gesture might involve a motion of some part of a user that is in contact with an interface element. For example, a user can perform a tactile gesture on a gesture input interface by moving a finger in a certain pattern on a surface. The surface may be part of an independent element such as a matt or pad, or can be integrated with other device elements such as on a computing device's surface, screen, mouse, etc.

Gestures also include visual gestures. A visual gesture includes motion of any part of a user including motion of physical elements held or worn by the user. A user may perform a visual gesture that includes making a motion that can be captured and recognized by one or more sensor devices (e.g., imagers) and associated circuitry. For example, a user can move a limb in a certain pattern in a sensing field of a gesture input interface. In response, the certain pattern can be captured and recognized as the user's desire to trigger one or a plurality of commands to control one or more devices.

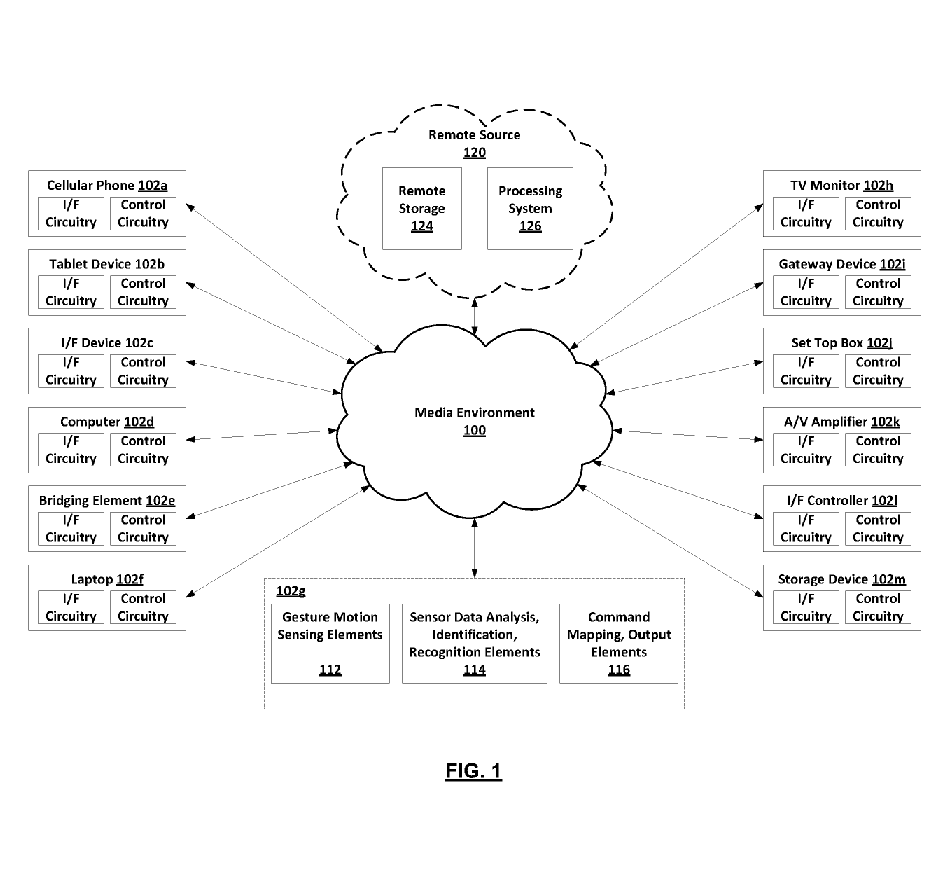

FIG. 1 is a diagram illustrating a media environment 100 according to various embodiments. A media environment can include various devices that can generate data, provide data for consumption by one or a plurality of users, and route data between various points. As shown in the illustrated embodiment, a media environment can include various devices 102a-m and elements 110. In addition, a media environment 100 can be linked to a remote source, various networks, media sources, etc. For example, media environment can be linked to a remote source 120 that can include a network, a cloud system, the Internet, another media environment, etc. A remote source can include various processing systems and storage locations. For example, remote source 120 can include a processing system 126, which can be supported by one or more instances of processing circuitry distributed across a network, a remote storage location 124, etc.

Various devices can be included in a media environment. For example, as shown in FIG. 1, such devices can include, without limitation, one or more of a cellular or smart phone 102a, a tablet computer device 102b, an interface device 102c, a computer 102d, a bridging element 102e, a laptop 10f, a television monitor 102h, a gateway device 102i, a set top box (STB) 102j, an A/V Amplifier 102k, an interface controller 102l, and a storage device 102m. Such various devices can include interface circuitry and control (processing) circuitry, as shown. Data can be stored local to the media environment, in a dedicated storage device 102m, or in one or a plurality of the various devices 102a-m in the media environment 100. Data can also be stored in a remote storage. For example, a remote storage location 124 in a remote source network 120 can be accessed by various devices 102a-m in the media environment to access data. For example, various media content can be accessed by various devices from a remote storage location 124. In addition, a remote processing system 126 can perform various processing functions for various devices 102a-m in the media environment. Furthermore, a remote source, such as a network like the Internet, can be accessed by various elements in a media environment to access various foreign devices and foreign media environments.

In some embodiments, various devices in a media environment are capable of supporting one or more of capturing a sequence of one or more gestures performed by one or more users, identifying (also referred to herein as “characterizing”) the various gestures performed, recognizing an identified sequence of gestures as mapped to one or more various commands, and executing the various mapped commands. The various elements supporting the various above functions can be located in a single device, distributed in multiple instances across multiple devices in the media environment, some combination thereof, or the like. FIG. 1 illustrates a device 102g that includes various elements supporting various aspects of a gesture processing framework. For example, gesture sensing elements 112 can capture various gesture inputs via one or more sensing elements or circuitry. Sensor data analysis, identification, and recognition elements 114 can process gesture motions captured by one or more gesture motion sensing elements to identify the gesture motions as various gesture inputs, and recognize the identified gesture inputs as mapped to various commands via one or more elements or circuitry. Command mapping and output elements 116 can map various gesture inputs to various commands, send mapped commands in response to recognizing a mapped gesture input, via one or more elements and circuitry.

In some embodiments, a user provides input to a device by performing a gesture motion that is sensed (“captured”) by a sensing element of the device, identified as a specific gesture input based upon correlation of the sensed gesture with a known gesture input, and execution of one or more commands recognized to be associated with the known gesture input. That is, one gesture can trigger one command or a plurality of commands (e.g., a sequence of commands). Likewise, a sequence of gestures can trigger one or more commands.

Commands to be executed upon identification of a gesture input can be pre-defined. For example, a device may include a set of commands that a user can execute by providing certain pre-defined gesture inputs. In some embodiments, a user can define commands to be triggered by certain gesture inputs. Gesture inputs can be pre-defined or created by a user, device, application, or the like. For example, a user may interact with a device having a gesture motion sensing element (also referred to herein as a gesture input interface) by instructing the device to record a gesture performed by the user. The gesture motion can be recorded through the gesture input interface and stored as gesture information. The gesture information includes information sufficient to identify a sensed gesture motion as a certain gesture input. The gesture information can be stored locally, on the device recording the gesture motion, on some other device, or on a network-based storage. In some embodiments, later performances of a gesture motion are compared against some or all of the gesture information to identify the captured gesture motion. Identification can include determining that the captured gesture motion correlates with the stored gesture information. For example, gesture information of a visual gesture motion can include an action motion video, a tracing video, extracted textual descriptions of the gesture, some combination thereof, or the like, against which subsequent sensed gestures are compared; a sensed gesture motion that correlates sufficiently with the gesture information can be identified as the gesture input with which the action motion video is associated.

In some embodiments, one or more devices in a media environment can be controlled, at least in part, by user interaction with one or more various input devices. Input signals sent by one or more input devices can be mapped to various commands (sometimes referred to interchangeably herein as “control signals”) sent to various output devices, such that one or more output elements responds to a recognition of a capture of a certain gesture input by sending a command to which the gesture input is mapped. For example, a tablet device 102b can send input signals to control output from a television monitor 102h, A/V amplifier 102k, or the like. Many devices, however, are not configured to receive input signals from gesture input interfaces. As an example, and without limitation, a television monitor 102h may be configured to execute commands based upon input signals from an interface controller 102l that utilizes buttons but cannot execute commands based upon gesture motions made by a user and captured by an interface device 102c.

In some embodiments, a gesture processing framework maps one or more gesture motions that can be performed by a user to one or more control signals associated with one or more devices. A user supported by various devices in a media environment 100 can create personalized gesture data that can include a personalized set of known gesture inputs, gesture maps of one or more gesture inputs to one or more control signals, etc. Personalized gesture maps can be stored in one or more storage locations in one or more devices 102 in a media environment 100. Personalized gesture maps and personalized gesture inputs can also be stored in a remote storage location. For example, in the illustrated embodiment, gesture maps, gesture inputs, macrosequences, and commands can be stored in a remote storage location 124 in a remote source network 120, such as a cloud storage system, and accessed by one or more devices 102. Remote storage locations can include duplications, in part or in full, of personalized data also location on a memory in a device 102. In an example, a cell phone 102a can access a personalized gesture map from a remote storage location 124 and use the gesture map to recognize gesture inputs and send mapped commands. In another example, the cell phone 102a can link with various applications in a remote source network 120, such as one or more various web-based applications, to process sensor data captured by one or more sensing elements 112 in media environment 100 and return identified gesture inputs configured to a certain standard format to one or more devices 102.

In some embodiments, personalized gesture data includes gesture maps that are associated with a particular device and/or user and are used by command mapping and output elements 116 included in one or more devices 102 to send certain commands mapped to certain recognized gesture inputs based upon which user provides the gesture inputs. For example, a user's gesture maps may be associated with a user account, which, when associated with sensor data captured by a certain device, prompts some part of the gesture processing framework to send control signals based upon the user's gesture maps. A user account can include gesture information and device configuration information. In some embodiments, an account is associated with one or more devices. For example, a smartphone 102a can be associated with a gesture map account, such that gesture motions captured by a sensing element 112 in the smartphone 102a can be processed to identify gesture inputs, and commands can be sent to one or more devices 102 in a media environment based upon a gesture map associated with the account when the smartphone 102 is in communication with the media environment 100.

In some embodiments, a gesture processing framework maps gesture inputs from various input devices to control signals based upon gesture maps associated with the various input devices. Association of gesture maps with devices can include associating one or more input devices with an account that includes one or more gesture maps. Accounts can be created via interaction with a device or some part of a media environment. In some embodiments, ad hoc accounts are created for devices entering a media environment, users supported by devices, or. For example, where a visitor interacts with a media environment, some part of the media environment can create an ad hoc account to associate with the visitor's associated devices. The visitor can manage the account from one or more devices, and the account can include predetermined gesture maps, maps acquired from other sources, etc. Accounts can be temporary and can expire. For example, visitor accounts can be terminated upon an elapse of time, a visitor device leaving communication with a media environment, or some combination thereof. Accounts can be stored in the various input devices, and gestures provided as input to each device can be identified as a gesture input and a mapped control signal sent from the input device according to the associated map. Accounts can also be pushed from a device, or pulled from a device, to another device that can map gesture inputs from each device based upon an associated gesture map or account. In some embodiments, inputs received from one or more devices in a media environment take precedence over inputs from other devices. Devices, accounts, and users in a media environment can be ranked. For example, inputs from higher-ranking devices can override potentially conflicting inputs from other devices. Precedence can be predetermined as part of an account associated with a user or device. For example, a homeowner can set his account to take precedence over accounts associated with visitors. Inputs received from an input device associated with the homeowner's account can override conflicting inputs received from devices associated with the visitor accounts.

In some embodiments, mapping of gesture inputs to control signals can be fully manual. For example, a device 102 interface circuitry can allow a user to select one or more pre-captured gestures (via gesture graphics, descriptive text, etc.) for one or more particular predefined control signals associated with one or more media devices in a media environment. Additional gestures can be recorded during such a process.

In some embodiments, gesture mapping is at least partially automated. Automatic mapping can be based on past mappings of similar devices and similar functions. For example, gesture mapping can include automatically mapping a certain gesture (e.g., a “hand-clap”) to a power-off control signal associated with every device detected by a device utilizing a gesture processing framework. In some embodiments, gesture maps can be associated with a certain one or more devices. A gesture processing framework can respond to detection of the certain devices by automatically applying the associated gesture maps with the detected devices. Automated mapping can be changed, modified, and managed by a user through a user interface on a device. For example, a user can interact with a device 102, via an interface, to map a certain gesture input with a generic control signal (sometimes referred to interchangeably herein as a “common” control signal, “universal” control signal, etc), such that some part of the gesture framework, upon detecting another device, will map the certain gesture input to the device-specific version of the generic control signal. In one example, a user may purchase an off-the-shelf TV monitor to replace a TV monitor 102h already present in a media environment, where at least part of command mapping and output elements 116 are located in cell phone 102a. The cell phone can interact with the off-the-shelf TV monitor to identify the commands specific to the new device. As discussed further herein, such commands can be accessed as part of device configuration information. Where the commands associated with the new TV monitor are the same as the commands used for the replaced TV monitor 102h, the same gesture map used to send mapped commands to TV monitor 102h can be used to send mapped commands to the new off-the-shelf TV monitor.

In the event that the commands associated with the new device and the old device are not the same, and as described further herein, one or more gesture inputs or old commands can be mapped to the new commands. For example, where a mapping element 116 determines that the old device commands and new device commands are associated with sufficiently similar functions, the mapping element can automatically establish new gesture maps to the new device's commands, based on the old gesture maps. Where conflicts between the old device's associated commands and the new device's associated commands are detected, new gesture maps may be established, old gesture maps may be discarded, etc.

In some embodiments, a single command may be common to multiple devices in a media environment. That is, a single command code can be received and executed by one or more devices. Where only one or some of the devices are to execute the command, the command can be associated with a particular gesture input sequence. For example, a first gesture input may be associated with a command that is common to TV monitor 102h and A/V amplifier 102k, but a gesture input sequence of the first gesture input and a second gesture input may be mapped as a sequence to a command sequence that sends the associated command to the TV monitor only. In some embodiments, GPS locations can be utilized to properly execute a common command in a restricted manner. For example, various devices 102 in the media environment 100 can include a location beacon, such as a GPS beacon, that is used to identify the spatial location of the device. A user's gesture motions, when performed in such a manner as to favor a certain location associated with a certain device 102, can be mapped to sending the common command to the certain device only.

A control signal (“command”) can control some part of a device, a program being run by one or more devices, an application being run from a cloud, or some combination thereof. For example, a control signal can include, without limitation, a signal to turn on a device, change the channel on a television device, access a webpage on a network browser program, interact with an application being run from a cloud or some combination thereof. In addition, a framework can map a gesture input originally mapped to one control signal to another similar control signal.

The various elements 112, 114, and 116 can be included, in one or a plurality of separate devices 102a-m in the media environment 100. Various such elements on various devices can interact to support gesture processing. In one example, where cell phone 102a includes command mapping elements 116, and one or more other devices in media environment 100 include sensing elements 112 and analysis, identification, and recognition elements 114, the cell phone 102a can access various gesture inputs identified from captured gesture motions, identify one or more mapped control signals, and send the mapped control signals to their relevant destinations. So, where a user carries a cell phone containing a user's personalized gesture input mappings into a room containing a media environment that includes one or more sensing elements and analysis elements, the gesture motions can be captured, analyzed, identified, and recognized by the elements already in the room, while the cell phone can identify and send the control signals mapped to the gesture input.

In another example, where the cell phone 102a also includes the analysis, identification, and recognition elements 114, the cell phone can receive gesture motions captured by sensing elements in other devices, identify one or more gesture inputs from the gesture motions, identify the mapped control signals, and send the mapped control signals. In a further example, where the cell phone 102a includes command mapping elements 116, but no sensing elements 112, analysis, identification, and recognition elements 114, various personalized maps, and recognized gesture inputs can be transferred from the cell phone 102a to another device, such as STB 102j. Transferred personalized maps can then be used to send commands mapped to recognized gesture inputs captured by other sensing elements in the media environment 100. In a further example, a cell phone 102a can transfer a personalized gesture map to another device 102, but retain the capability to send the mapped commands. That is, another device may recognize an identified gesture input as being mapped to a certain command and send a signal indicating such to the cell phone 102a, and the cell phone 102a can send the mapped command. The cell phone 102a can request a final authorization from a supported user, via an interface, before sending the mapped command.

In another example, the cell phone 102a includes the at least some of the analysis, identification, and recognition elements 114, such that gesture motions are captured by sensing elements 112 located on other devices 102 in the media environment 100, identified as various gesture inputs using at least some analysis, identification, and recognition elements 114 located on other devices in the media environment 100, and the gesture inputs are accessed by the cell phone 102a to be recognized as gesture inputs that are mapped to control signals, which can then be sent by the cell phone 102a. Identified gesture inputs can be accessed as data from other devices via an API. Identified gesture inputs accessed via an API can be received at an application in a device, which compares the gesture inputs against a database of gesture input sequences, gesture maps, control signal maps, macrosequences, etc., to recognize mapped gesture inputs.

In a further example, where the cell phone 102a includes at least the analysis, identification, and recognition elements 114 and command mapping and output elements 116, the cell phone 102a can access sensor data including gesture motions captured by sensing elements 112 included in other devices 102 in media environment 100, identify gesture inputs from processing the sensor data, recognize the gesture inputs as mapped to one or more various commands, and send the mapped commands. The quality and format of sensor data can be controlled via communication with devices including the sensing elements 112. For example, some part of a cell phone 102a can interact with a device 102 including sensing elements 112, via an API to configure the format and resolution associated with sensor data.

In some embodiments, commands (“control signals”) can include establishing a handshake with another one or more devices, receiving acknowledgement indications from various devices, accessing data, processing data, etc. Commands can also be sent directly to a desired device, via one or more intermediary devices

By interacting with various devices in the media environment, a device can select one or more devices with which to interact to support a gesture processing framework. For example, in the illustrated embodiment, where cell phone 102a includes all of elements 112, 114, and 116, the cell phone can still select to receive gesture motions from another sensing element 112, in addition or in alternative, from another device 102 in the media environment.

In some embodiments, data can be exchanged according to one or more industry standards. A gesture processing framework can include sending signals in a certain standard format. In one example, one or more of sensing elements 112 analysis, identification, and recognition elements 114, and command mapping and output elements 116 can send signals in a standardized format. Such a format can include an industry standard. For example, a standard can involve using a CEC code standard for sending sensor data including captured gesture motions from sensing elements 112, and sending mapped commands from command mapping and output elements 118. In another example, cell phone 102a can control various local devices 102 in the media environment, as well as various remote devices via a remote source 120, using a CEC control infrastructure. In some embodiments, a device can receive data and send data pursuant to an application programming interface (API), which can be two-way. In a further example, where a cell phone 102a is the only device in a media environment that includes elements 112, 114, and 116, but the media environment 100 includes devices configured to receive CEC standard commands, the cell phone 102a can send mapped CEC commands to various devices based on sensor data captured by sensing elements 112 on the cell phone 102a.

In addition, one or more of the sensor data analysis, identification, and recognition elements 114 and command mapping and output elements 116 can be accessed from a remote source 120. In one example, sensor data, including gesture motions captured by one or more devices 102, can be sent to a remote processing system 126 for analysis, and the identified gesture input can be sent back to a device 102 for recognition and output of a mapped command. In another example, identified gesture inputs can be forwarded from various devices 102 to processing system 126 to be recognized as mapped to command, and the mapped command to be sent from the processing system 126 to another device to be executed.

In some embodiments, one or more gesture inputs and control signals are combined into a macrosequence. Macrosequences can include one or more gesture inputs that are mapped to one or more control signals. For example, macrosequence can include a single gesture input (e.g., a hand-wave visual gesture) can be mapped to a sequence of multiple control signals (e.g., turn on all proximate devices, set volume to maximum, set channel to predetermined channel, etc.). A macrosequence can also include a sequence of gesture inputs that are mapped to one or more control signals. A sequence of gesture inputs, and control signals can include a parallel sequence, serial sequence, or some combination thereof. For example, a macrosequence can include a parallel sequence of two separate gesture inputs, to be performed substantially simultaneously, that are mapped to a serial sequence of three particular control signals.

In some embodiments, a bridging element or infrastructure, referred to herein as a “bridge”, some other device, or the like, collects configuration information from one or more of various input media devices (“input devices”) and output media devices (“output devices”) in a media environment and utilizes the collected information to associate input signals with output signals so that one or more input devices can control, provide media content to one or more output devices. For example, a device that includes a user account with a gesture map of a gesture input mapped to a generic control signal can collect configuration information from a detected device, identify specific control signals associated with the detected device, and map the gesture map to the specific control signal such that the gesture input is mapped to the specific control signal. Mapping a gesture map to a specific control signal can include associating a generic control signal in the gesture map with the specific control signal.

A bridge can be located in one or more input devices, output devices, or some other device in the media device network. For example, the bridge can be located in a “dashboard” device external to the other input devices and output devices in the media device network, including, without limitation, a Set Top Box (STB). The bridge can also be located in a separate network, including, but not limited to, a network layer domain. Configuration information can include, but is not limited to, CEC (Consumer Electronics Control) codes, EDID (Extended Display Identification) information, power up/down codes, remote control codes, video capabilities, interface control support, gesture input information, etc. Inputs and outputs can include, but are not limited to, media content and control signals.

In another example, a device can respond to a media environment by collecting configuration information associated with various parts of the media environment, map various gesture inputs, and/or gesture maps to control signals included in the configuration information, collect information related to the media environment, control some part of the media environment via mapped gesture inputs, utilize collected information and gesture mapping to transfer outputs between devices in the media environment, and transfer outputs between media environments. For example, a device that encounters a first media environment, such as a television and stereo system coupled to a set top box, may collect configuration information associated with each of the devices in the media environment, utilize the configuration information to map gesture inputs and/or gesture maps associated with an account on the device to control signals for each of the devices in the media environment. In addition, the device can collect information related to a program being played via the television and stereo, such that the device can respond to a particular input by transferring the program-viewing experience to another media environment (e.g., a second television) such that, upon encountering the second television, the device tunes the television to display the same program that was displayed on the first television. Such transfer can include collecting channel information from the second television, comparing the collected channel information with information from the first television to identify which channel to tune the second television channel to, etc.

In some embodiments, a device relays a selected group of signals between two or more media devices in a media environment while processing other signals locally before passing them on. Processing can include, but is not limited to, translation of the signals, and mapping one or more signals to another one or more signals. For example, different HDMI device vendors may use different CEC command groups to support the same or similar functionality, such as <User Ctrl> and <Deck Ctrl> are both used by some vendors to support playback control. The device can, in some embodiments, implement a logic to probe and maintain, in its internal implementation, the “CEC capability set” of HDMI devices connected to the system, in order to determine when and how to translate an incoming CEC input message before relaying it to receiving devices. For example, where two or more media devices from two different vendors are connected in a media environment, the device may relay CEC signals that are generic and do not require translation to be understood by the receiving devices. However, the bridge may translate CEC signals that are vendor specific or otherwise non-generic, such that the CEC signal can be understood by the receiving device. Signals can be translated to be vendor-specific to, generic, or some other signal configuration. This functionality improves interoperability across devices from different vendors and extends functionality of control mechanisms, including, but not limited to, CEC functionality, over a media environment.

A media environment can include, but is not limited to, wired configurations, wireless configurations, a combination of wired and wireless configurations, etc. The above description is applicable to other environments as well, is not limited to a media environment, and can involve control of any type of device, using any type of communication standard.

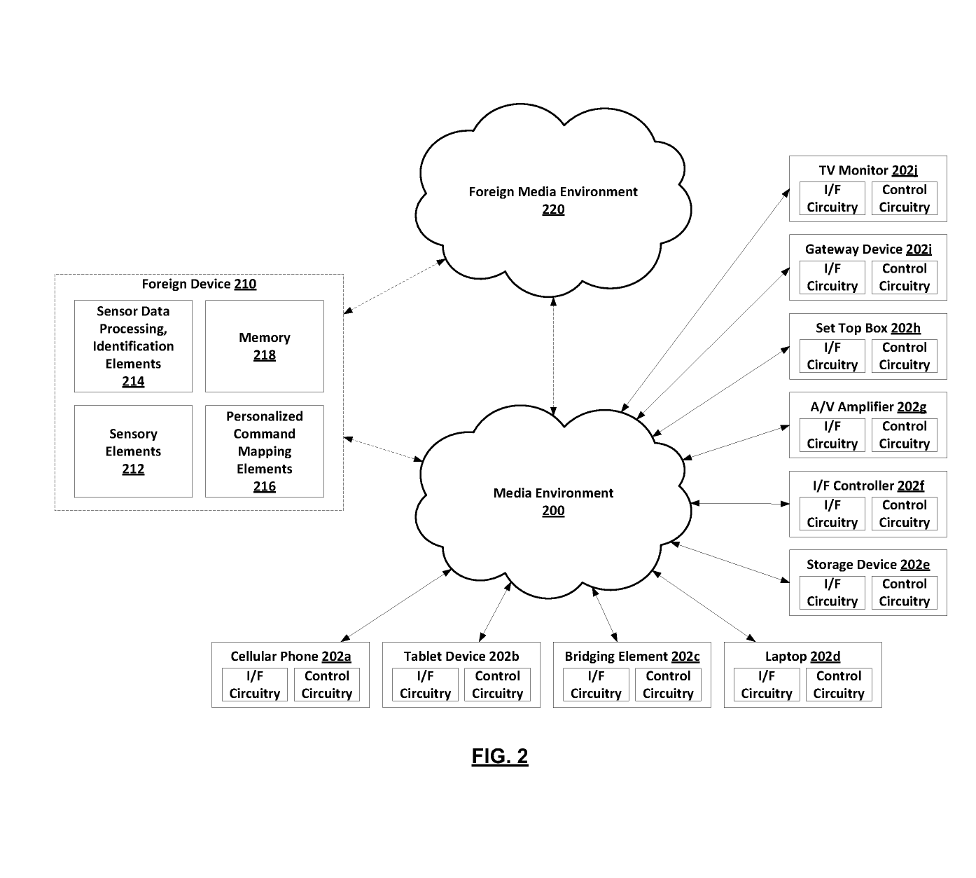

FIG. 2 is a diagram illustrating a media environment 200 according to various embodiments. A media environment can interact with a device which is foreign to the media environment (a “foreign device,” “visitor device,” “guest device,” etc.); such interaction can include, without limitation, personalized mapping of gesture inputs to commands to control various devices, accessing and processing received sensor data to identify gesture inputs and recognize them as mapped to various commands, and the like. As shown in the illustrated embodiment, a media environment 200 can include various devices 202a-i, which are similar to the devices 120 discussed further above with reference to FIG. 1. In addition, a media environment 200 can be linked to a foreign device, which can enable personalized gesture mapping to various commands using data located on the foreign device. As shown in the illustrated embodiment, a foreign device, which can be a similar type of device as any of the devices 202 illustrated, can include some or all of the illustrated elements including, without limitation, sensory elements 212 that can capture gesture motions as sensor data, sensor data processing and identification elements 214 that can process captured sensor data to identify one or more gesture inputs from the sensor data, personalized command mapping elements that can associate one or more gesture inputs with one or more commands, recognize an identified gesture input as currently mapped to one or more commands, and send a mapped command in response to recognizing a mapped gesture input. Gesture maps can be personalized by a user supported by the foreign device, by the foreign device itself, or some combination thereof. Personalized gesture maps can be established through a command mapping element 216, and personalized gesture maps can be stored in a memory 218 of the foreign device, along with characteristics of known gesture inputs, etc. In this way, a portable foreign device supporting a user, such as a cell phone, can store the user's personalized gesture data and be transported between various environments.

In some embodiments, the various elements 212-218 illustrated in foreign device 210 can be distributed, in one or more instances, across various devices 202 of a media environment 200 or foreign media environment 220. For example, in the illustrated embodiment, foreign device 210 can be a cell phone that includes only a memory 218 that stores one or more users' personalized gesture data in the form of one or more gesture maps. The stored gesture maps can be maps of gesture inputs to generic commands, maps to device-specific commands of the user's home media environment, maps to specific commands of one or more public environments, one or more gesture maps acquired from a third party, etc. Upon encountering the environment 200, a foreign device 210 including only memory 218 can provide the stored personalized gesture data to one or more devices 202 that include one or more of memory, mapping elements, recognition elements, etc. Once the personalized gesture data is transferred to one or more devices in the media environment, the cell phone foreign device 210 might no longer be used for gesture processing, as the sensory elements 212, sensor data processing, and identification elements, and personalized command mapping elements 216 may be included, in part or in full, in one or more devices 202. Additional mappings of personalized gesture data can be added to the personalized gesture data copies stored in media environment 200, and an updated copy of the data can be sent to the foreign device 210 to update its stored copy. The media environment 200 may include various processing systems, interfaces, and the like that are used to process gestures captured by sensor elements 212 based upon stored personalized gesture data. In another example, all of elements 212-218 can be absent from media environment 200, such that foreign device 210 accesses device configuration information associated with one or more devices 202, maps the stored personalized gesture data as needed, and then sends mapped commands to the various devices 202 in response to identifying the corresponding gesture inputs from gesture information captured by the sensory elements.

In some embodiments, a foreign device can manage which devices and elements are involved in gesture processing. For example, where foreign device encounters a media environment 200 that includes multiple sensory elements, but the user only desires to interact with a single sensory element, the foreign device can restrict which devices are involved in gesture processing. Sensory elements may be instructed to not capture any gesture motions; alternatively or in addition, sensor data from various sensory elements may be ignored or discarded. In embodiments where multiple instances of various elements 212-218 are located in a foreign device 210 and media environment 200, one or more elements 212-218 can be selected to perform a relevant part of gesture processing. Such a selection can be made based on transmission path capabilities, processing efficiency, user desire, internal logic, etc.

In some embodiments, mapping of a personalized gesture data can proceed as described herein. In one example, a copy of personalized gesture data received by a device in media environment 200 can be mapped to commands associated with local devices 202, any or all known commands stored in one of devices 202, or the like. In some embodiments, a foreign device can be more active in interacting with an encountered media environment. In one example, foreign device 210 includes, in addition to memory 218, various sensory elements 212, and various command mapping elements. Such a device 210 can, after providing personalized gesture data to various devices 220 in media environment 200, capture gesture motion information via the sensory elements, send the gesture motion information to be analyzed by one or more devices 202, receive an identified gesture input that was recognized as mapped to a generic command, and send a mapped command to the associated device. In such an example, the foreign device 210 can request confirmation of the command from a user, via a user interface, prior to sending the command.

In some embodiments, as discussed above, various devices in a media environment can interact with remote devices, applications, services, content, etc. via a link to a remote network. Such interaction can be used to access media content, provide data to be processed on a network processing system, such as a cloud computing system, and the like. For example, foreign device 210 having sensory elements 212 can access personalized gesture data from a cloud storage device in a remote network, access a network processing system to process sensor data, and the like. Such a use of a remote network may be made based on various factors. For example, network-based processing systems may be used only in the event that no equivalent processing systems or circuitry are found in any other device in media environment 200 and foreign device 210.

In some embodiments, a device encounters various foreign media environments and utilizes a locally-stored personalized gesture data to support a user's ability to use his personalized gesture inputs to execute the same mapped commands, regardless of the environment that he is in. As shown in the illustrated embodiment, a foreign device 210 or media environment 200 can themselves encounter a foreign media environment 220. A foreign media environment can, in some embodiments, include the same types and quantities of devices found in a media environment 200.

A media environment, foreign media environment, and the like can include, but is not limited to, wired configurations, wireless configurations, a combination of wired and wireless configurations, etc. The above description is applicable to other environments as well, is not limited to a media environment, and can involve control of any type of device, using any type of communication standard.

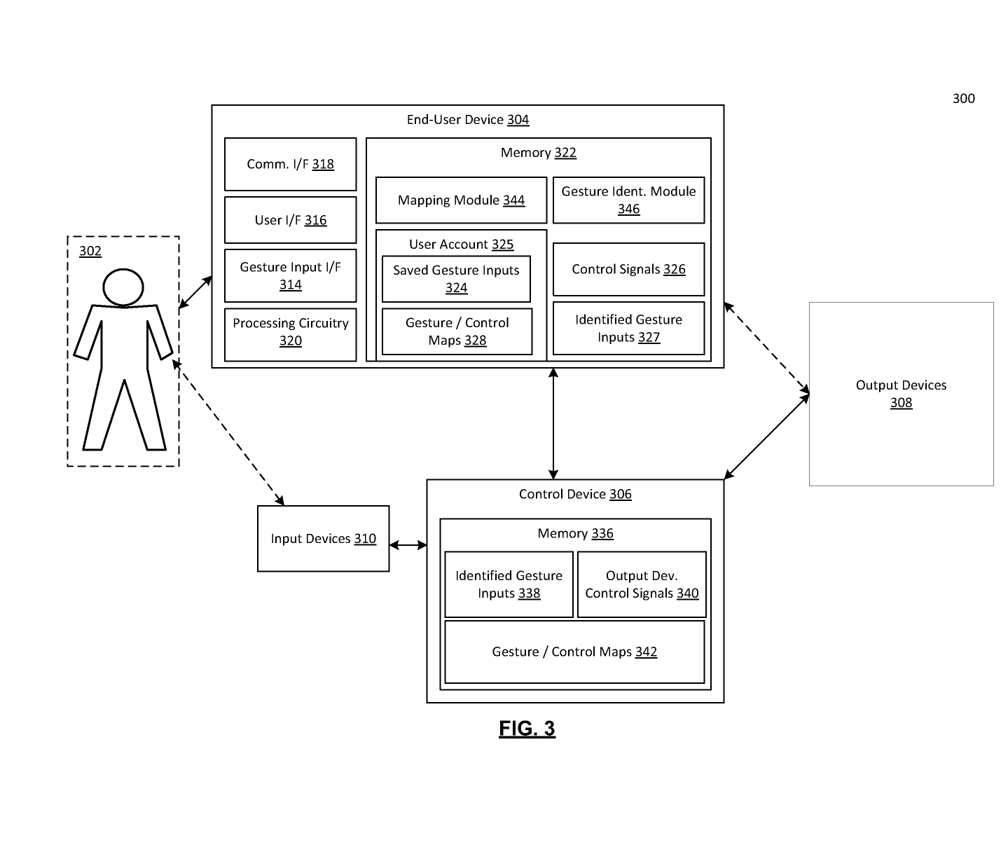

FIG. 3 is a diagram illustrating a media environment 300 that includes various end-user devices 304 and input devices 310 linked to various output devices 308 and a control device 306 across a combination of network links, which can be bridged by one or more of the devices in the media environment 300.

End-user device 304 can include various interfaces, memory, and processing circuitry. For example, in the illustrated embodiment, end-user device includes a communications interface 318, a user interaction interface 316, a gesture input interface 314, a transcoder 334, processing circuitry 320, and memory 322. The communication interface 318 can communicatively couple (e.g., “link”) the end-user device 304 with other devices, services, environments, etc. For example, in the illustrated embodiment, end-user device 304 is linked to a control device 306, and the end-user device 304 can link with one or more output devices 308 in the media environment 300.

In some embodiments, a user 302 can interact with the end-user device 304 via one or more of a user interface 316 and a gesture input interface 314 to map various gestures to one or more control signals. As shown in the illustrated embodiment, end-user device 304 can include memory 322 that can store a set of identified gesture input signals 327, control signals 326, user account information 325, mapping module 344, gesture identification module 346, etc. Identified gesture input signals 327, control signals 326, and account information 325 can be created and/or altered by a user 302 via interaction with the end-user device 304, acquired from a remote source, etc. For example, end-user device 304 can pull identified control signals 326 from a control device or network at periodic time intervals, upon updates, upon user command, based on internal logic, etc. User account information 325 can include information that is specific to one or more users 302 of end-user device 304, media environment 300, the end-user device 304 itself, or some other device. The user account information 325 can include various gesture input signals 324 and gesture maps 328 that include the mapping of one or more gesture input signals to one or more control signals. In some embodiments, saved gesture inputs 324 include user-defined gesture input signals and identified gesture input signals include predefined gesture input signals. A user can create new gesture input signals by recording a gesture input via one or more interfaces on end-user device 304, some other linked input device 310, defining various characteristics of the recorded gesture input, and associating the gesture input 324 with the user account 325. In addition, the user 302 associated with a user account 325 can map one or more saved gesture inputs 324 and identified gesture inputs 327 with one or more predefined control signals 326, and user defined control signals to create one or more gesture maps 328, which can be associated with one or more accounts 325. The mapping can be performed by some part of the end-user device 304. For example, as shown in the illustrated embodiment, end-user device 304 includes memory 322 that includes a mapping module 344. The mapping module 344 can be utilized to map various gesture inputs to control signals to generate a gesture map. In some embodiments, the gesture map includes a database involving gesture input signals and control signals, as discussed and illustrated below.

In some embodiments, the end-user device 304 responds to gesture inputs by identifying the gesture input signal, and sending the mapped control signal. For example, in the illustrated embodiment, gesture identification module 346 can be utilized to identify gesture inputs received from a user 302 by comparing the gesture input with gesture information associated with saved gesture inputs 324, identified gesture inputs 327, etc. A gesture input can be received via a gesture input interface 314, or a separate input device 310. In some embodiments, the gesture input can be identified as a particular gesture input signal where the received gesture input correlates with the particular gesture input signal. Where the gesture input correlates with multiple gesture input signals, the end-user device may request additional input from the user to confirm the control signal that the user intended to be sent. Such a confirmation can be provided via a user interface 316, or some other device in the media environment 300.

In some embodiments, the end-user device utilizes one or more confidence levels in identifying a gesture input signal. Where a correlation between a received gesture input and a particular gesture input signal exceeds a threshold confidence level, the received gesture input can be identified as the gesture input signal and a mapped control signal can be sent. Where the correlation does not exceed this level, the user 302 can be queried for confirmation that the received gesture input is intended to correlate to the one or more gesture input signals to which the received gesture input correlates most closely. In some embodiments, confidence levels can be adapted over time based upon gesture inputs. For example, where a gesture input is always indicated by the user to correlate with a known gesture input signal, but the received gesture input consistently fails to exceed an initial confidence level threshold, the confidence level threshold may be lowered to account for the high probability that a received gesture input is intended to correlate with the known gesture input signal. In another example, gesture information associated with the known gesture input signal may be altered over time to account for the specific variations of a gesture made by a particular user in providing gesture input.

In some embodiments, an end-user device 304 responds to a media environment 300 by mapping gesture inputs with control signals specific to various devices, programs, and applications associated with the media environment 300. Such mapping can include interactions with one or more control devices, or bridges. For example, in the illustrated, embodiment, end-user device 304 is linked with control device 306, which can include a memory 336 that stores various identified gesture input signals 338, various gesture maps 342, and various control signals 340 for particular output devices 308 in the media environment 300. The end-user device can interact with the control device 306 to map various gesture inputs to control signals to control various parts of the media environment 300. For example, upon detecting the media environment 300, an end-user device that includes a user account 325 with gesture maps and saved gesture input signals 324 can interact with control devices 306 and/or output devices 308 to acquire configuration information of the output devices 308 including, without limitation, control signals for one or more of the output devices 308. As shown in the illustrated embodiment, some or all of the configuration information, such as output device control signals 340, can be located at the control device 306. The end-user device 304 can associate the existing gesture maps 328 with the collected configuration information to associate the gesture maps with the output device control signals 340 to establish control maps. Some part of the end-user device 304, such as the mapping module 344, can compare collected output device control signals 340 with control signals 326 to which gesture input signals are mapped in the gesture maps 328. Upon determining a correlation between the collected output device control signals 340 and the control signals to which the gesture input signals are mapped in the gesture maps 328, an association can be established between particular output device control signals and one or more of the associated gesture input signals and control signals. For example, where the gesture map 328 includes a gesture input signal mapped to a generic control signal, and an output device control signal 340 is different from the generic control signal, the end-user device can associate one or more of the gesture input signal and the generic control signal with the output device control signal 340 in a control map. When the selected gesture input signal is identified from a received gesture input, the associated output device control signal 340 can be sent, in addition to or in alternative of the generic control signal.

In some embodiments, the end-user device 304 can map a stored set of gesture inputs and gesture maps to a plurality of foreign media environments, such that a common set of gesture input signals can be utilized to send control signals that are executable by various parts of each of the plurality of media environments. For example, where end-user device 304 encounters a first media environment that includes output devices with a first set of output device control signals, the end-user device can map a stored set of gesture maps, and gesture input signals, to the first set of output device control signals, thereby enabling control of the output devices in the first media environment. In addition, the same end-user device can encounter a second media environment that includes output devices with a second set of output devices and map the stored gesture inputs, and gesture maps to the second set of output device control signals. In some embodiments, the end-user device can store a plurality of accounts 325, one or more of the accounts 325 having different gesture maps 328 of various gesture input signals and control signals. Which gesture input signals, gesture maps, etc. are mapped to output device control signals in a media environment 300 can be determined by one or more of the accounts 325 being active on the end-user device, a control device 306, or the like. For example, where a user 302 activates his personal account 325 on end-user device 304, gesture input signals received from the user 302 at end-user device 304 can be processed according to gesture maps 328 and saved gesture input signals 324 in the user's own account 325.

In some embodiments, the end-user device 304 can pass some parts of the gesture processing framework to other devices in a media environment. For example, where end-user device 304 detects control device 306, the end-user device 304 can transmit the user account information 325 stored locally to the control device 306, such that the gesture information and gesture maps can be utilized without the end-user device being required to process gesture input signals, map gesture input signals, or gesture maps to various output device control signals, etc. For example, where a user 302 provides gesture input to media environment 300 via input device 310, the account information located at control device 306 can be utilized to send the mapped control signals without further interaction with the end-user device.

In some embodiments, an end-user device 304 receives user input from an input device 310 linked to the end-user device 304. The end-user device 304 can instruct the input device 310 to relay user inputs to the end-user device for processing. The end-user device 304 can also push gesture mapping information and functionalities to input device 310 to perform input processing at least partially independently of end-user device 304. For example, where end-user device 304 stores saved gesture inputs 324 and gesture maps 328 associated with a user's 302 account 325, the end-user device 304 can respond to detection of an input device 310 in media environment 300 by forwarding the gesture information related to the saved gesture inputs 324, and the gesture maps 328 to input device 310 and instruct the input device to process gesture inputs received from user 302. In another example, end-user device 304 can pull gesture inputs received at input device 310 for processing to identify gesture input signals and execute mapped control signals, based upon the account-associated gesture maps.

Input devices 310 can include, but are not limited to, a touchscreen device (e.g., a touchpad, a pad device, an iPad, iPhone, etc.), a gesture input device, an Audio/Stereo device, a Video HDMI device, a mouse, a keyboard, and the like. In some embodiments, an end-user device 304 is the input device 310. Output devices can include, but are not limited to, a High-Res video device, 3D goggles, a 7.1 Surround Sound Audio device, a microphone, etc.

Network links can include, but are not limited to, one or more various transport media. For example, various network links in a media environment can include an HDMI wired link, a 4G wireless link, a Bluetooth wireless link, or some combination thereof. Other transport media may be considered to be encompassed by this disclosure, including, but not limited to, cellular, 3G wireless, IR (infrared) receivers, LTE (3GPP Long Term Evolution), Ethernet/LAN, and DCL (Data Control Language), and the like.

In some embodiments, a device in media environment 300 bridges links between one or more devices in the media environment 300 by transcoding signals received from one device to be transported successfully to a linked device. For example, in an embodiment where signals received from an input device over a first network link are CEC commands over a wired HDMI link, and signals transmitted to an output device over a second network link are WiFi signals, a bridging device may process CEC signals received over the first network link to be transported over the second network link; such processing can include, but is not limited to, transcoding the signal, encapsulating the signal for wireless transport, and translating the signal.

In some embodiments, a bridging device is a bridge that can function at least in part as a control device 306. For example, as shown in the illustrated embodiment, a bridge can be part of a control device 306, which can send control signals to one or more output devices 308. Control device 306 can be remotely programmed to match certain input signals from one or more input devices 310 and end-user devices 304 with certain output control signals. Such matching programming can be determined by a control data stream, control input from a user, control input from a device, or some combination thereof.

In some embodiments, control device 306 bridges control of one or more of output devices 308 by one or more input devices 310, end-user devices 304, and the like by, in response to receiving a certain one or more gesture input signals, generating one or more output signals to be transmitted to one or more output devices 308. Output signals can be control signals to control some aspect of an output device and/or media content. Control device 306 may perform such generation of certain output signals in response to receiving certain gesture input signals in response to some internal logic, or a user command to associate a certain input device, input signal with a certain output device, or output signal. The user command include, without limitation, a gesture input signal received from an end-user device 304 linked to the control device 306.

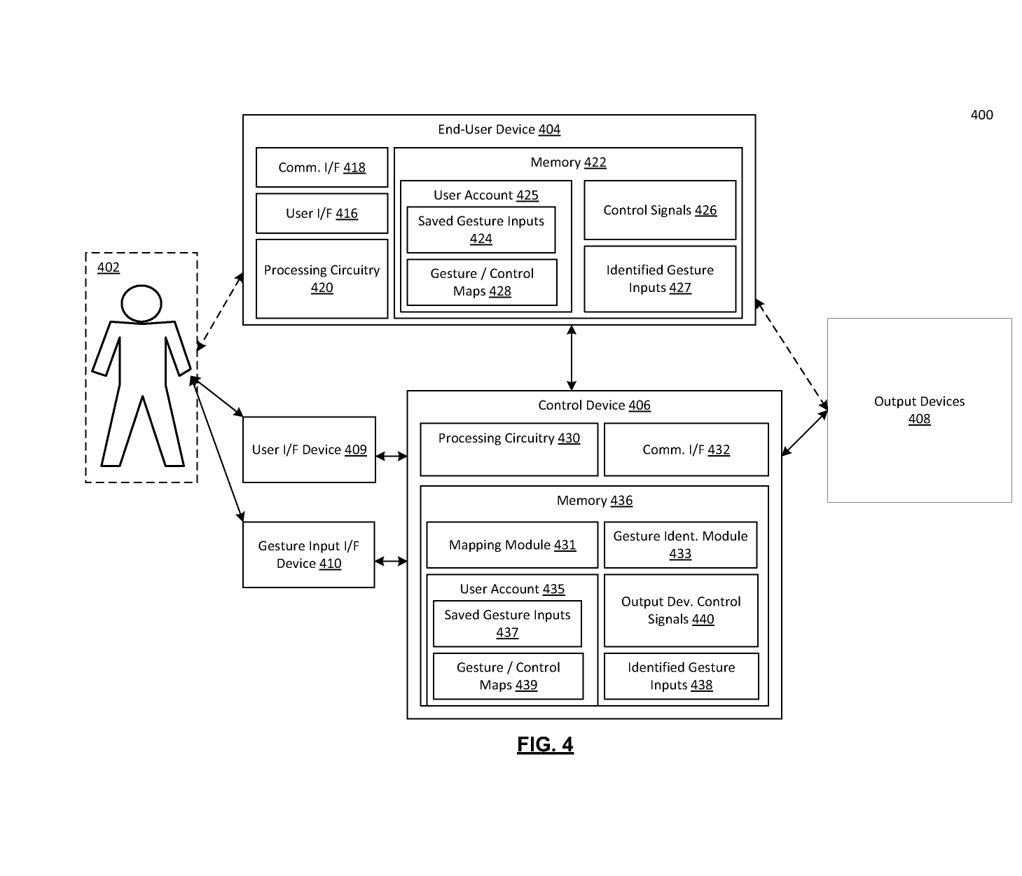

FIG. 4 is a diagram illustrating a media environment 400 that includes various end-user devices 404 and input devices 409 and 410 linked to various output devices 408 and a control device 406 across a combination of network links, which can be bridged by one or more of the devices in the media environment 400.

In the illustrated embodiment, end-user device 404 includes, in addition to processing circuitry 420 and interfaces 416 and 418, a memory 422 that can store user account information 425 that includes gesture information 424 associated with various saved gesture input signals, and gesture maps 428; memory 422 can also store various control signals and identified gesture input signals including, without limitation, various generic control signals and predefined gesture input signals.

In some embodiments, a control device in a media environment manages gesture mapping of gesture input signals to output device control signals, based upon gesture input signals, and gesture maps acquired from a user. In the illustrated embodiment, for example, control device 406 includes processing circuitry 430 that can respond to detection of a device entering the media environment 400 by requesting gesture mapping-related information from the detected device. The control device 406 can interact with other parts of a media environment 400 via one or more various communication interfaces 432. Where the detected device is an input device, interface device (e.g., interface devices 409 and 410), or the like, control device 406 can manage interactions between signals from an input device and signals to an output device. For example, control device 406 can serve as a bridging element to bridge communications between an interface device 409 and an output device 408. Control device 406, in some embodiments, can transcode signals, generate output signals based upon signal mappings.

In some embodiments, the control device can utilize various information associated with a detected device to manage mapping of various input signals to various control signals. For example, where the detected device is an end-user device 404, the control device 406 can request some or all of user account information 425, identified gesture input signals 427, control signals 426, and the like. In some embodiments, the control device 406 stores acquired information in a local memory 436. For example, as shown in the illustrated embodiment, memory 436 can include user account information 435, saved gesture input information 437, gesture maps and control maps 439, mapping module 431, and gesture identification module 433. Memory 436 can also include output device control signals 440 and identified gesture inputs 438. In some embodiments, control device 406 collects the output device control signals 440 as part of configuration information that the control device solicits and/or receives from various devices in the media environment 400. For example, upon detecting a new output device 408 coupling to the media environment 400, the control device 406 can interact with the new output device 408 to collect configuration information from the device, including control signals 440 associated with the new output device 408. The control device 406 can utilize a mapping module 431 included in memory 436 to map gesture inputs and gesture maps associated with one or more user accounts to the collected output device control signals 440. In addition, the control device 406 can associate certain input interfaces, and input devices with one or more accounts. Such associations can be based upon some information includes in user account information 425 and 435, or some internal logic. For example, in the illustrated embodiment, control device 406 can, having collected user account information 425 and mapped the collected gesture map 428 to locally stored output device control signals 440, associated the user account 425 with gesture input signals received from end-point device 406, such that gesture input signals received from the end-point device 404 are identified and mapped to control signals based upon one or more gesture maps, and gesture input signals associated with the user account information 425. Gesture input signal identification can be managed via a module 433 located in memory 436 of control device 406.

In some embodiments, control device 406 establishes ad hoc accounts for visitors and new devices in a media environment. Ad hoc accounts can be established to include a set of predetermined saved gesture input signals gesture maps. In addition, ad hoc accounts can be temporary, subject to additional restrictions over standard accounts, or some combination thereof. For example, an ad hoc account established by a control device 406 and associated with a visitor end-user device may not include gesture maps for all of the output device control signals associated with output devices 408. In addition, the ad hoc account may be terminated after an elapse of time, effectively terminating gesture-mapped control of the output devices via end-point device 404. The elapse of time can run from when an associated device leaves the media environment, from when the associated device joins the media environment, upon a command associated with a user account having a higher precedence, or some combination thereof.

In some embodiments, control device 406 can establish user account information, map gesture input signals, etc. based upon user interactions with one or more interface and input devices. For example, a user 402 can interact directly with control device 406, or via one or more interface devices 409 and 410 to establish a user account, record gesture inputs, map gesture input signals to control signals, or some combination thereof.

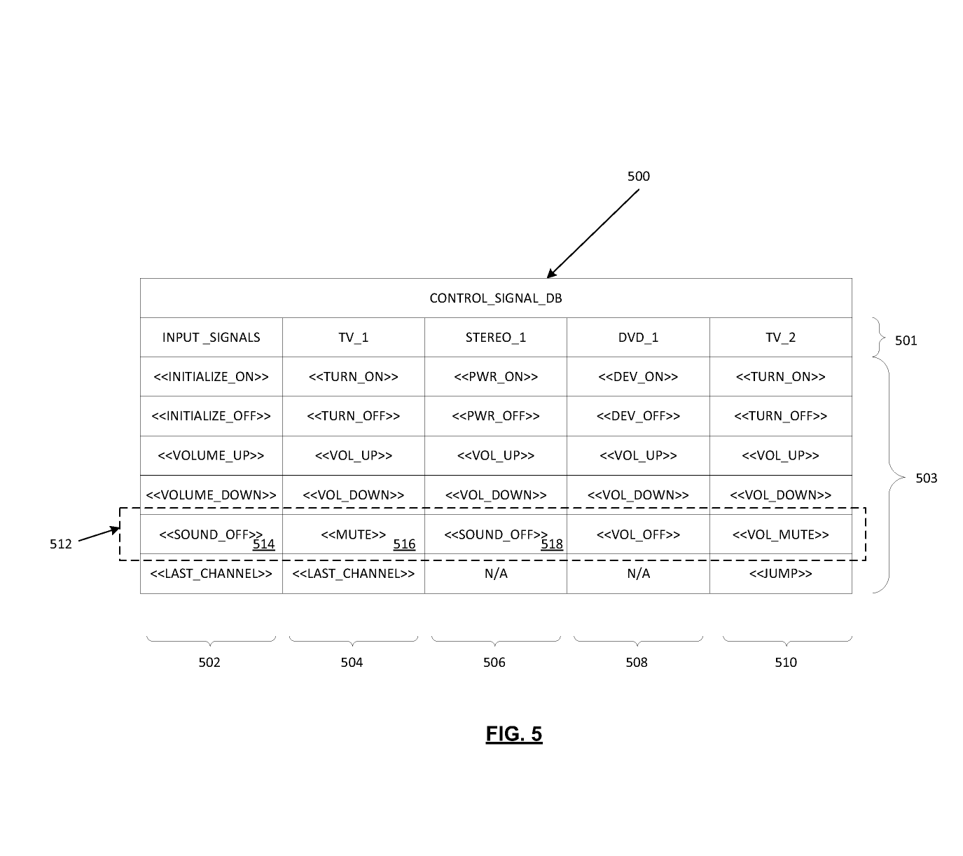

FIG. 5 is a diagram illustrating a database that maps various generic control signals with various output device control signals, according to various embodiments.

In some embodiments, a control signal database 500 associates various control signals associated with various devices in a media environment. As shown in the illustrated embodiment, a database 500 can include one or more sets 502, 504, 506, 508, and 510 of control signals. The database can be organized such that control signals 503 in each set are associated with a label 501 identifying the set.

In some embodiments, the database 500 can be managed by one or more instances of processing circuitry in the media environment, including, without limitation, one or more devices, services, or applications associated with the media environment. For example, the database 500 may be included in an end-user device, which collects output device control signals associated with various output devices from various sources. In addition, the database 500 may include various generic control signals collected from various sources. Various sources of generic control signals and output device control signals can include, without limitation, input from a user via a device in a media environment, one or more output devices, a bridging element, a control device, a service available via interaction with a network, some combination thereof, etc. Control signals can be pushed or pulled from various sources according to a predetermined update schedule, intermittently, based upon various communication conditions, based upon user input, or on an ad hoc basis.

In some embodiments, collected output device control signals can be associated with one or more various output devices in the database. In addition, various devices and signals in the database 500 can be associated with each other in the database 500 such that various control signals that are executed by various devices to perform similar tasks can be associated. Association can include associating various devices in a media environment with one or more sets of control signals, such that one or more control signals in the sets are associated with one or more output device control signals associated with the various devices. Associations of control signals can enable mapping of input signals that are mapped to one or more control signals including, without limitation, generic control signals, to be mapped to various output device control signals. For example, in the illustrated embodiment, a first set 502 of control signals includes various generic control signals. Other sets 504, 506, 508, and 510 of control signals in the database 500 are each associated with one or more output devices. The sets can be associated with output devices that are coupled to a currently-detected media environment, such that the sets are deleted from the database within a period of time of communication with the media environment or output device terminating. In addition, one or more sets associated with a particular output device or media environment can remain in the database 500, even though communication with the output device, or media environment is currently terminated. Sets of control signals can be generated based upon configuration information collected from one or more sources, which can include, without limitation, control signals. Updates can be made to various sets over time, including, without limitation, via user input, acquisition of updated configuration information from various sources, etc.

In some embodiments, various sets of control signals are associated such that one or more control signals associated with a first set are associated with one or more control signals associated with a second set. Such associations of control signals can be part of a mapping of control signals, and can be based upon a determined similarity between control signals, input from an information source, some internal logic, etc. For example, as shown in the illustrated embodiment, a first set 502 that includes generic control signals can be associated with various sets 504, 506, 508, and 510 associated with various output devices. In some embodiments, the association of control signal sets can include associating control signals that instruct various devices to perform a similar function. As shown in row 512, the first set 502 includes a generic control signal 514 that instructs a generic device to mute audio output. In the association of the first set 502 with set 504, the generic control signal 514 is associated with a signal 516. The association can be based upon a determination that control signal 516 is a device-specific variation of generic control signal 514, such that control signal 516 instructs a device associated with set 504 to mute audio output.

In some embodiments, an association between control signal 514 and control signal 516 is part of a mapping of a gesture input signal to various control signals. For example, where a gesture input signal is already mapped to generic control signal 514, an association of control signal 514 and control signal 516 can include mapping the gesture input signal to control signal 516. Such mapping can be included in a gesture map of the gesture input signal to control signal 514, included in a control signal map of the gesture input signal to the control signal 516, included in a control signal map of control signal 514 to control signal 516, or some combination thereof. In addition, as illustrated by row 512, a control signal 514 can be associated with multiple control signals from multiple sets. In some embodiments, an association between control signals in various sets can include no additional mapping. For example, as shown in the illustrated embodiment, where control signal 518 is associated with control signal 518, which is the same, no additional mapping of signals is required, as signal 518 is identical to signal 514.

In some embodiments, associations can occur automatically, without user input. For example, where a database 500 includes a first set 502 of control signals, an entity may respond to detection of a media environment or device by acquiring configuration information related to the media environment or device that is utilized to populate database 500 with one or more sets of control signals 504 506 508, and 510 that can be associated with first set 502. One or more of such detection, acquisition, population, and association can occur without requiring any input from a user of a device, or notification of the user of the device. Further, modifications, updates, and terminations can proceed automatically, such that the user does not participated in the process and is otherwise not notified of its occurrence.

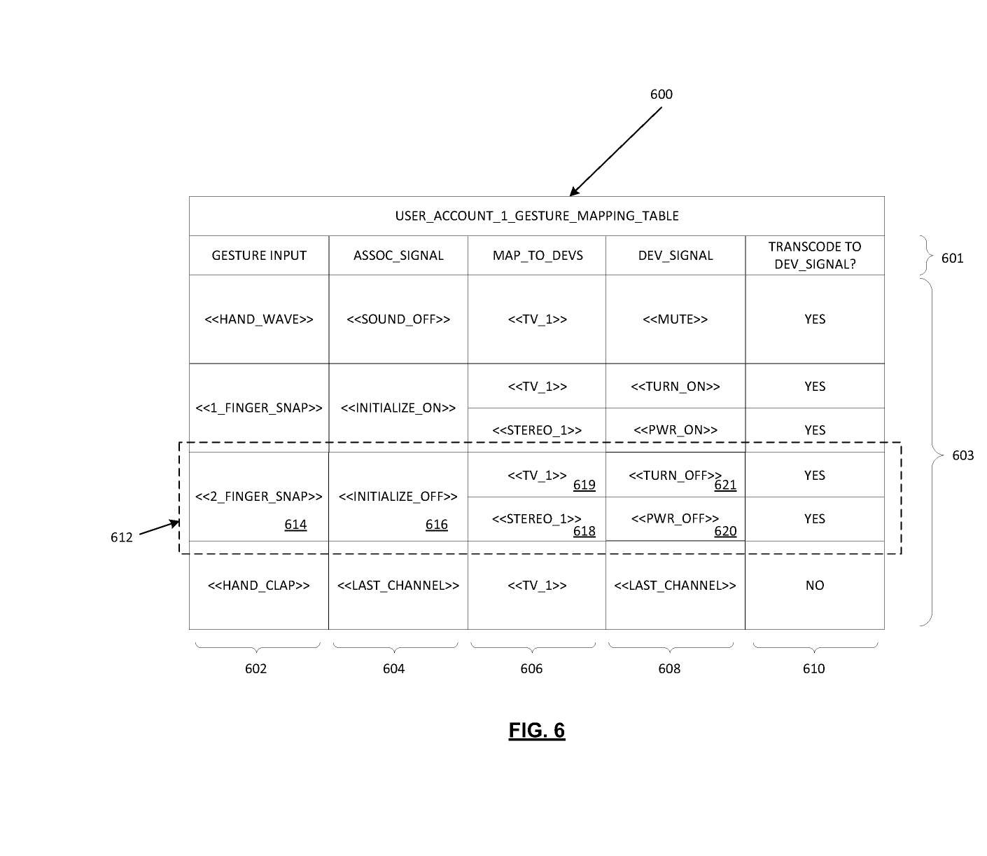

FIG. 6 is a diagram illustrating a database that maps various gesture input signals with various output device control signals, according to various embodiments.

As shown in the illustrated embodiment, a mapping database 600 can include various maps various gesture input signals to various output device control signals. In some embodiments, gesture maps are associated with one or more user accounts. Such association can be used to determine which gesture map to utilize, based upon a user account associated with an input interface, a device, a media environment, or some combination thereof. For example, a user account can be associated with a device having a gesture input interface, such that gesture input signals received from the device via the gesture input interface are processed based upon one or more gesture maps associated with the user account. In another example, a user account can be activated on a device, such that some part of the device interacts with a media environment to associate inputs from one or more gesture input interfaces with a gesture map associated with the user account. The device can, in some embodiments, send user account information, including, without limitation, a gesture map, to another device in a media environment, where the another device processes input signals from input devices associated with the user account based upon the gesture map.

In some embodiments, database 600 includes a set of one or more gesture input signals 602, each represented in the illustrated embodiment by an identifier. A gesture input signal can include gesture information that can be used to identify a received gesture input from a gesture input interface as the gesture input signal. As discussed above, such gesture information can include, for example, a tracing video of a particular gesture. As discussed above, the gesture input signal can be identified by comparing a gesture input with the gesture information. The gesture input can be information generated by a gesture input interface in response to an interaction with a user. For example, a tactile gesture input interface can record a pattern made by a user's finger on the interface as a gesture input. The gesture input can be compared with gesture information associated with one or more gesture input signals to identify the gesture input as one or more of the gesture input signals. As discussed above, such identification can involve determining whether the gesture input correlates with a gesture input signal to within a threshold confidence level.

In some embodiments, the gesture information includes an identifier that can indicate the gesture input signal. As shown in the illustrated embodiment, a gesture input signal 614 can be indicated by an identifier <<2_FINGER_SNAP>>. An identifier can provide some indication of the nature of the indicated gesture input signal. For example, the identifier of gesture input signal 614 can indicate that the gesture input signal involves two snaps of a user's fingers. An identifier can be established based on user input, based upon some internal logic of a device, service, or application.

In some embodiments, database 600 includes one or more sets of control signals to which one or more gesture input signals are mapped to establish one or more gesture maps. Gesture maps can be utilized by one or more devices, services, applications, or some combination thereof, to process identified gesture input signals. Such processing can include sending control signals to which an identified gesture input signal is mapped. For example, in the illustrated embodiment, row 612 of database 600 illustrates that a gesture input signal 614, represented by indicator <<2_FINGER_SNAP>>, is mapped to a control signal 616, itself represented by an indicator <<INITIALIZE_OFF>>. In some embodiments, mapping of a gesture input signal to a control signal occurs automatically, without any input from a user. For example, a gesture input signal can be mapped to a control signal based, at least in part, upon a likelihood of sending the control signal and a likelihood of user ease in providing the gesture input signal. In another example, a user is presented, via an interface, with representations of gesture input signals and control signals. The user can interact with the interface to manually map a gesture input signal to a control signal by establishing an association between the gesture input signal and the control signal. The association can be included in a gesture map, which identifies the mapping of one or more gesture input signals to one or more control signals. The gesture map can be associated with a user account, a media environment, a device, etc.

A gesture map can be used to respond to a gesture input signal by sending a control signal. Such a map can be utilized by a device that receives a gesture input from a user, an output device that executes the control signal, a device that bridges a link between an input device and an output device, some combination thereof, etc. For example, as shown in the illustrated embodiment, where a “finger-snap” gesture input signal 614 is mapped to a control signal 616 that commands a device to turn off, a device, service, application, or processing system utilizing the gesture map can respond to identifying a received gesture input as gesture input 614 by sending control signal 616. In some embodiments, the control signal 616 can be a generic signal that is sent to any linked device, or service, application. The control signal 616 can be specific to a certain device, or type of device. For example, in the illustrated embodiment, control signal 616, like the other control signals in set 604, are generic control signals. In response to identifying receipt of gesture input signal 614, control signal 616 may be sent to one or more devices linked to a device that processes the received gesture input.

In some embodiments, a gesture input signal mapped to a control signal can be further mapped to an output device control signal. Such a mapping can be part of the gesture map, discussed above, part of an addition control signal map, or some combination thereof. Such a mapping can occur automatically, in response to detection of a media environment. For example, where database 600 is part of an end-user device, and the device detects a media environment, the device can respond to the detection by collecting configuration information from the media environment, the configuration information including, without limitation, indicators of various devices in the media environment and various control signals associated with the various devices. The device can add the control signals to the database 600 and map the existing gesture input signals, and gesture maps to the collected control signals, such that the device can respond to identification of a received gesture input signal by sending one or more control signals to control some part of the media environment.

For example, in the illustrated embodiment, column 606 identifies various output devices in a media environment. A processing system, processing circuitry, service, or application can associate certain control signals, gesture input signals, etc. with control signals associated with one or more certain devices based upon user input, or internal logic. In the illustrated embodiment, various control signals 604 are associated with various output device 606 according to an internal logic of the device. Internal logic can include associating a given control signal with every output device control signal that is determined to relate to a similar command. For example, as illustrated in row 612, control signal 616 is associated with output device control signals 620 and 621, which are each respectively associated with devices 618 and 619, based upon determining a similarity between control signals 616, 620, and 621. Such an association can be modified by user input, interaction with another part of the media environment, various dynamics in the media environment, etc.

In some embodiments, an association between a control signal and a device control signal establishes a mapping of a gesture input signal to the device control signal. For example, as shown in the illustrated embodiment, where gesture input signal 614 is mapped to control signal 616, and control signal 616 is associated with control signals 620 and 621, gesture input signal is mapped to control signals 620 and 621, such that a gesture input can be processed to identify gesture input signal 614 and respond to such identification by sending control signal 620 to output device 618 and send control signal 621 to output device 619. In circumstances where a one or more gesture input signals are processed to send multiple control signals, the control signals can be sent simultaneously (in parallel), sequentially (in series), some combination thereof, or the like. For example, where a received gesture input is identified as gesture input signal 614, control signals 620 and 621 can be send to output devices 618 and 619, respectively, simultaneously.

In some embodiments, various device control signals can be transcoded based upon an internal logic or user input. For example, various output device control signals can be encoded to provide a measure of security for the control signal. As shown in the illustrated embodiment, various control signals can be identified by a necessity for transcoding in column 610. Such a necessity can be determined by configuration information, whether a generic control signal is sent, etc.

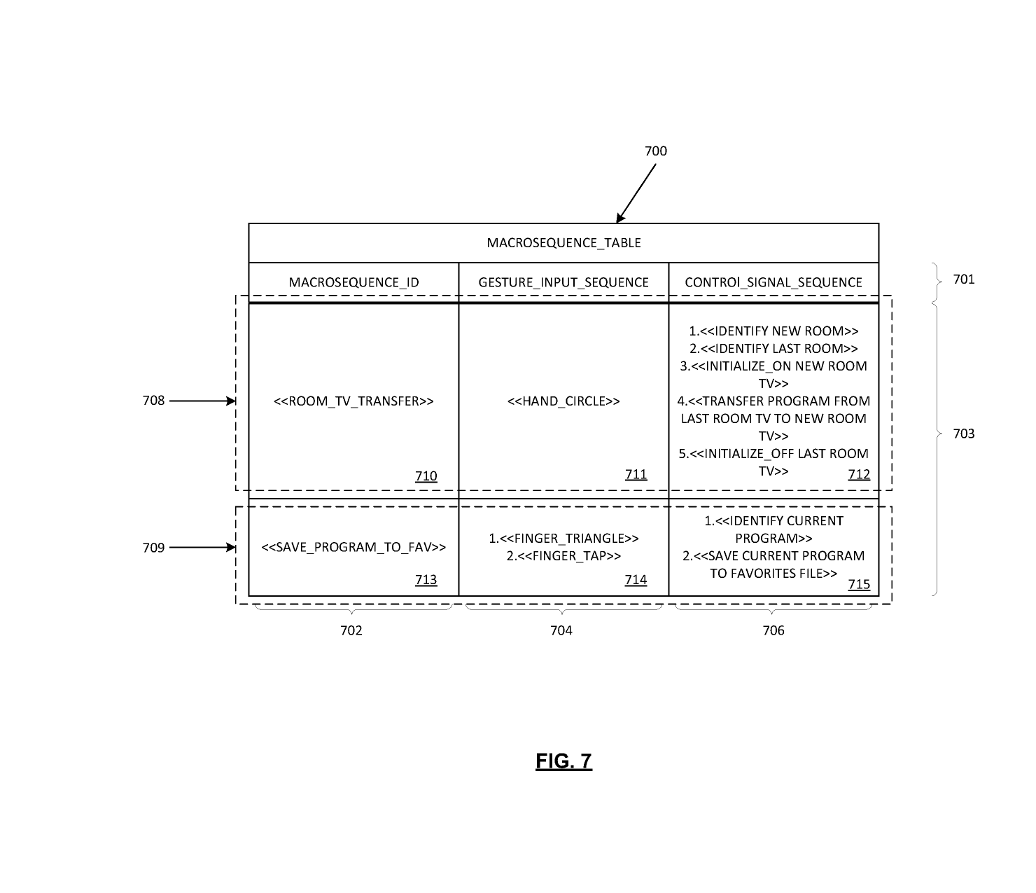

FIG. 7 is a diagram illustrating a database 700 that maps various gesture input signal sequences with various output control signal sequences as a macrosequence, according to various embodiments.

The database 700 can include various macrosequences 703 organized by various indicators 701. A macrosequence in database 700 can include an identifier 702 that indicates the macrosequence, a sequence 704 of one or more gesture input signals that, when identified, triggers the macrosequence, and a sequence 706 of one or more control signals that is performed when the macrosequence is triggered.

In some embodiments, a macrosequence can enable a wide variety of separate actions to be performed based upon a specific input sequence. For example, a macrosequence can include a single particular gesture input signal mapped to a sequence of multiple control signals, such that the macrosequence can be processed to respond to identification of the particular gesture input signal by performing the control signal sequence.

In some embodiments, a macrosequence can be part of a gesture map, as described above in further detail. The gesture map can be supported by a gesture processing framework to respond to identification of a gesture input sequence of a certain mapped macrosequence by performing the mapped control signal sequence. Identification of a gesture input sequence can include tracking gesture inputs over a period of time. As a gesture input sequence can include multiple gesture input signals that can be received simultaneously, sequentially, or some combination thereof, a gesture processing framework can identify a received gesture input as a gesture input signal and identify a pattern of received gesture input signals as a gesture input sequence. Identification of a gesture input signal is discussed in further detail above. Identification of a gesture input sequence can include, without limitation, tracking gesture inputs received over a period of time to determine whether various gesture input signals are part of a gesture input sequence. For example, where a gesture input signal is identified from a received gesture input signal, a gesture processing framework can include tracking additional received gesture input signals within a certain period of time. Gesture input signals received within a certain period of time can be assembled and compared with known gesture input sequences to determine if the gesture input signals correlate to a gesture input sequence. Upon determining that the gesture input signals correspond to a gesture input sequence, the gesture input signals are identified as such and a control signal sequence that is part of the macrosequence can be performed.

Performance of a control signal sequence can include, without limitation, simultaneously sending various control signals to various different destinations, sending various control signals in a predefined sequence to a single destination device, or some combination thereof. For example, as shown in the illustrated embodiment, database 700 includes a macrosequence 708, indicated by identifier 710, which includes a gesture input sequence 711 that includes a single gesture input signal and a control signal sequence 712 that includes five control signals.

In some embodiments, a processing of a macrosequence includes responding to identification of a received gesture input as a gesture input sequence by performing a control signal sequence that comprises performing multiple actions and control signals. The control signals in a control signal sequence can be sent simultaneously, sequentially, or some combination thereof. For example, as shown in the illustrated embodiment, macrosequence 708 corresponds to transferring display of a program on a television in a first room to a television in a second room. Such a macrosequence can be supported by a user device, or control device in response to receiving a gesture input sequence from a user moving from the first room to the second room. The user can, upon moving to the second room, perform gesture input sequence 710, which comprises a single gesture input signal of the user moving his hand in a circular motion. The gesture input made by the user can be captured by a gesture input interface and processed by a gesture processing framework. The received gesture input can be identified as the gesture input signal <<HAND_CIRCLE>>, and as the gesture input sequence 711. Upon identifying the gesture input signal 711, a gesture processing framework can respond by performing control signal sequence 712, which comprises multiple control signals. For example, the gesture processing framework can identify the second room, identify the first room, turn on the television in the second room, transfer a program that is being displayed on the television in the first room to the television in the second room, and then turn off the television in the first room. The various actions and control signals in control signal sequence 712 can occur simultaneously sequentially, or some combination thereof.

In some embodiments, a processing of a macrosequence includes responding to identification of multiple received gesture inputs as a gesture input sequence by performing a control signal sequence that comprises performing one or more particular actions, and control signals. The gesture input signals in a gesture input sequence can be identified simultaneously, sequentially, or some combination thereof. For example, as shown in the illustrated embodiment, macrosequence 709, indicated by identifier 713, corresponds to saving a program that is currently being displayed by a part of a media environment to a particular “favorites” file in a memory in response to identifying a particular gesture input sequence of multiple gesture input signals. As shown, gesture input sequence 714 includes two gesture input sequences of a triangular pattern traced out on a tactile gesture input interface, and a single tap of tactile gesture input interface. A gesture processing framework can identify the gesture input sequence 714 by tracking identified gesture input signals such that, where the two gesture input signals that comprise gesture input sequence 714 are determined to have been identified within a certain period of time, the two gesture input signals are associated and compared with known gesture input sequences. In some embodiments, a gesture input sequence may include a sequence of gesture input signals received sequentially in a certain order, such that tracked gesture input signals are identified as a gesture input sequence if identified in the certain order. For example, in the illustrated embodiment, gesture input sequence can include the first and second gesture input signals being received sequentially, with the <<FINGER_TAP>> gesture input signal following the <<FINGER_TRIANGLE>> gesture input signal. The gesture input sequence 714 can be identified where identified gesture input signals are identified in the order indicated for gesture input sequence 714. Upon determining that the two tracked gesture input signals correlate to gesture input sequence 714, a gesture processing framework can identify gesture input sequence 714 and perform control signal sequence 715. As shown, control signal sequence 715 can include identifying a currently-displayed program in a media environment and saving the program to a certain file in a memory.

In some embodiments, a macrosequence is established manually, via user input, automatically, or via some internal logic. For example, a user can interact with a user interface to establish a macrosequence by associating various gesture input signals to establish a gesture input sequence, associate various control signals, and actions to establish a control signal sequence, associate a gesture input sequence with a control signal sequence to establish a macrosequence, and associate a macrosequence with an identifier. The user can utilize predefined gesture input signals, identifiers, control signals, and actions in establishing a macrosequence; the user can also create one or more of same via interaction with one or more interfaces including, without limitation, a gesture input interface. In another example, a gesture processing framework can establish a macrosequence automatically, without receiving or requesting user input, by mapping a predefined gesture map, that includes an association of a gesture input signal to a generic control signal, to multiple output device control signals, in response to associating the gesture map with the multiple output device control signals, such that the gesture processing framework responds to identification of the gesture input signal by sending the multiple output device control signals.

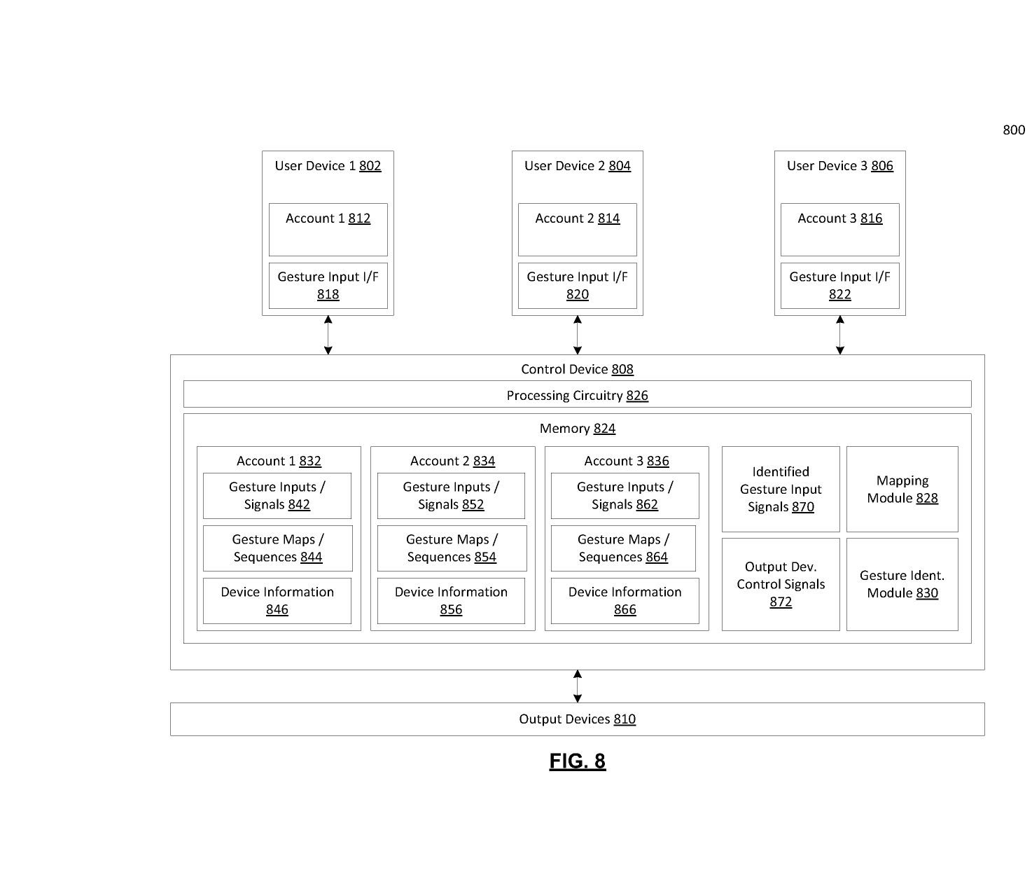

FIG. 8 is a diagram illustrating a media environment 800 that includes various end-user devices 802, 804, and 806 linked to various output devices 810 and a control device 808 across a combination of network links, which can be bridged by one or more of the devices in the media environment 800. For example, as shown in the illustrated embodiment, control device 808 can bridge links between end-user devices 802, 804, and 806 and output devices 810.

In some embodiments, a gesture processing framework can be supported by a control device in a media environment to process gesture inputs received from various devices based upon various gesture maps, and control signal maps. For example, as shown in the illustrated embodiment, each of end-user devices 802, 804, and 806 includes a respective account 812, 814, and 816, which can be stored in respective memories local to the respective end-user devices. An account can include various account information including, without limitation, saved gesture input signals, control signals, gesture maps, and control signal maps. The accounts can be associated with one or more devices, users that can interact with one or more devices, users supported by one or more devices, or some combination thereof. In the illustrated embodiment, each account 812, 814, and 816 is associated with the respective end-user device 802, 804, and 806 in which it is locally stored.

In some embodiments, control device 808 can respond to detecting various devices in media environment by acquiring information from the various devices. For example, control device 808 can respond to detecting each of end-user device 802, 804, and 806 by acquiring account information included in accounts 812, 814, and 816 from each of the respective end-user devices. In addition, control device 808 can acquire various device information associated with the device, including, without limitation, device capabilities, and identifiers. Account information can be acquired by pulling the information from a device, requesting transmission of the information by the device, etc. Acquisition of account information can be automatic upon detection of a device, and it can be transparent to a user interacting with media environment 800.

In some embodiments, information acquired from a device is managed as account information. As shown in the illustrated embodiment, account information acquired from end-user devices 802, 804, and 806, respectively, can be stored in memory 824 as accounts 832, 834, and 836, respectively. Each account in control device 808 can correspond to an account from which account information is acquired. In the illustrated embodiment, for example, account 832 corresponds to account 812, such that information included in account 832 includes account information acquired from account 812. Each “account” in memory 824 can include, without limitation, various saved gesture input signals, control signals, gesture maps, control signal maps, macrosequences, and device information associated with a corresponding account. As shown in the illustrated embodiment, for example, account 832 includes various saved gesture input signals and control signals 842, gesture maps and macrosequences 844, and device information 846 associated with corresponding account 812. Likewise, respective accounts 834 and 836 include information associated with corresponding accounts 814 and 816, respectively. In some embodiments, an account can be established upon acquiring information from a device, via user input, etc., and persist even after communication with the device or user is terminated. For example, where a user interacts with control device 808 via an interface to create an account 832 that is to be associated with a certain end-user device 802, the user can specify that the account 832 is to persist in memory 824 regardless of whether end-user device 802 is detected. The account 832 can also be updated periodically or upon detection of a corresponding device 802. In some embodiments, an account is temporary and can be terminated. For example, control device 808 can establish account 832 upon detection of end-user device 804 and populate account 834 with information acquired from device 834, and predefined information acquired from various sources. The account 834 can be terminated upon various conditions including, without limitation, termination of a link between control device 808 and end-user device 804, elapse of a period of time, upon receiving a signal from another device, upon receiving a single from a certain user via one or more interfaces, or some combination thereof.

In some embodiments, memory 824 includes various information acquired from various sources over time. For example, memory 824 can include, in the illustrated embodiment, a set of gesture input signals 870, which can include some or all gesture input signals 842, 852, and 862 acquired from various end-user devices 802, 804, and 806, gesture input signals acquired from various output devices 810, and gesture input signals acquired from various services and applications. In addition, memory 824 can include various output device control signals 872 acquired from various output device 810. The output device control signals 872 can include control signals associated with output devices 810 currently linked to control device 808, a predefined set of control signals acquired from various sources over time, or some combination thereof.

In some embodiments, control device 808 can support a gesture processing framework that processes gesture inputs, and gesture input signals received from various gesture input interfaces based upon associations between gesture maps, control signal maps, and the gesture input interfaces. Such processing can include responding to a particular gesture input signal received from a certain input device by sending a certain control signal to which the gesture input signal is mapped in a gesture map associated with the certain input device. For example, accounts 832 and 834 can be respectively associated with end-user devices 802 and 804, such that gesture inputs received from gesture input interfaces 818 and 820, respectively, can be processed differently based on information in accounts 832 and 834, respectively, including, without limitation, saved gesture input signals 842 and 852, gesture maps, control signal maps, and macrosequences 844 and 854. An association of an account in memory 824 that corresponds to an account on a device with gesture inputs and gesture input signals received from a gesture input interface coupled to the device can be based upon account information acquired from the device, input received from a user, some internal logic, etc. For example, an account 832 established on control device 808 using account information acquired from account 812 on end-user device 802 can be automatically associated with the end-user device 802, such that a gesture input or gesture input signal received from end-user device 802 is processed based upon information associated with account 832 including, without limitation, saved gesture input signals 842, a set 844 of gesture maps, control signal maps, macrosequences, or some combination thereof. A “hand-wave” gesture input captured by gesture input interface 818 coupled to end-user device 802 can be received by control device 808, identified based upon comparison with saved gesture input signals 842 associated with account 832 that corresponds to account 812, and a certain control signal can be sent to one or more output devices 810 based upon a gesture map 844 associated with account 832 that maps the identified gesture input signal to the certain control signal.

In some embodiments, control device 808 can identify a gesture input received from a particular input device as a particular gesture input signal based upon comparison of the received gesture input with saved gesture inputs associated with the input device. For example, as shown in the illustrated embodiment, account 836, which corresponds to account 816 associated with end-user device 806, includes a set 862 of saved gesture input signals, and control signals acquired from account 816. A gesture input captured by gesture input interface 822 coupled to device 806 can be sent to control device 808, which can identify the gesture input by comparing it to the saved gesture input signals 862 associated with account 836. Identification can be supported by a gesture identification module 830 included in memory 824. Where the received gesture input cannot be identified based upon such comparison, the gesture input can be compared to one or more other various sets of gesture input signals including, without limitation, a gesture input set 842 and 852 associated with another account, a set 870 of identified gesture input signals, or some combination thereof.

In some embodiments, a gesture input signal, gesture map, or the like associated with an account based upon information acquired from a linked device can be mapped to various control signals acquired from one or more linked output devices. For example, as shown in the illustrated embodiment, control device can acquire gesture inputs signals and gesture maps from various linked end-user devices 802, 804, and 806 and acquire various output device control signals from various linked output devices 810. The control device 808 can include a mapping module 828 included in memory 824 that can be utilized to map various gesture input signals and gesture maps to various output device control signals. For example, the mapping module 828 can be utilized to map a gesture map 844, that maps a certain gesture input signal with a generic control signal, with a certain output device control signal by associating the generic control signal and the output device control signal 872, to establish a control signal map, such that at least some part of control device 808 can respond to receiving the gesture input signal from end-user device 802 by sending the output device control signal to which the mapped generic control signal is mapped. In another example, mapping module 828 can be utilized to, upon associating the mapped generic control signal to the output device control signal 872, map the gesture input signal directly to the output device control signal 872 to establish a gesture map, such that at least some part of control device 808 can respond to receiving the gesture input signal from end-user device 802 by sending the output device control signal to which the gesture input signal is mapped.

In some embodiments, processing gesture input signals received from various devices based upon various respective gesture maps, or control signal maps associated with the respective devices enables processing similar gesture input signals differently based upon the different associations. For example, where a first hand-wave gesture input is received by control device 808 from end-user device 802, and a second hand-wave gesture input is received by control device 808 from end-user device 804, the first hand-wave gesture input can be processed using a saved gesture input signal 842 and a gesture map 844 associated with account 832 to send a first control signal to one or more output devices 810, while the second hand-wave gesture input can be processed using a saved gesture input signal 852 and a gesture map 854 associated with account 834 to send a second control signal to one or more output devices 810.

In some embodiments, device information associated with an account can include precedence information that enables inputs received from one device to override inputs received from another device. In a media environment, multiple input devices can send input signals to control various output devices. Some input signals received from various input devices can be contradictory or conflicting. For example, in the illustrated embodiment, a gesture input signal received from end-user device 802 can be mapped to a control signal to turn down the volume on a particular output device 810, while another gesture input signal received from end-user device 804 can be mapped to a control signal to turn up the volume on the same output device 810. Where the two gesture input signals are received within a certain period of time including, without limitation, substantially simultaneously, precedence information associated with each end-user device can be utilized to determine how to process the two gesture input signals. Precedence information can be included in device information 846, 856 and 866 associated with respective accounts 832, 834, and 836. Device information can be acquired from a corresponding device, established via user input, established based upon some internal logic, etc. For example, media environment 800 is located in a home, and end-user device 802 is associated with the homeowner, the homeowner may interact with control device, via end-user device 802, an interface coupled to control device 808, or some combination thereof, to establish precedence information that is processed to give input signals received from end-user device 802 precedence over input signals received from any other input device within a certain period of time. In some embodiments, precedence information associated with various accounts can be processed to respond to a first input signal received from a device associated with a high precedence level by ignoring a second input signal received from a device associated with a low precedence level, where the second input signal and the first input signal are mapped to a similar control signal. Inputs associated with lower precedence accounts can be subject to additional confirmation before a mapped control signal is sent, including, without limitation, requiring a device associated with a higher precedence account to allow the mapped control signal to be sent.

In some embodiments, various elements are distributed across multiple various devices in the media environment 800. For example, control device 808 can be one of the output devices 810, and vice versa. Furthermore, the various processing and memory elements illustrated in FIG. 8 for control device 808 can be distributed across multiple devices. For example, user device 1 802 can include a gesture input interface 818 and a mapping module 828, while user device 2 includes a gesture identification module 830. In such an example, gesture motions captured by the gesture input interface 828 are analyzed by the gesture identification module 830 in user device 2 804, and the identified gesture inputs can be returned to user device 1 802 to be mapped to one or more commands.

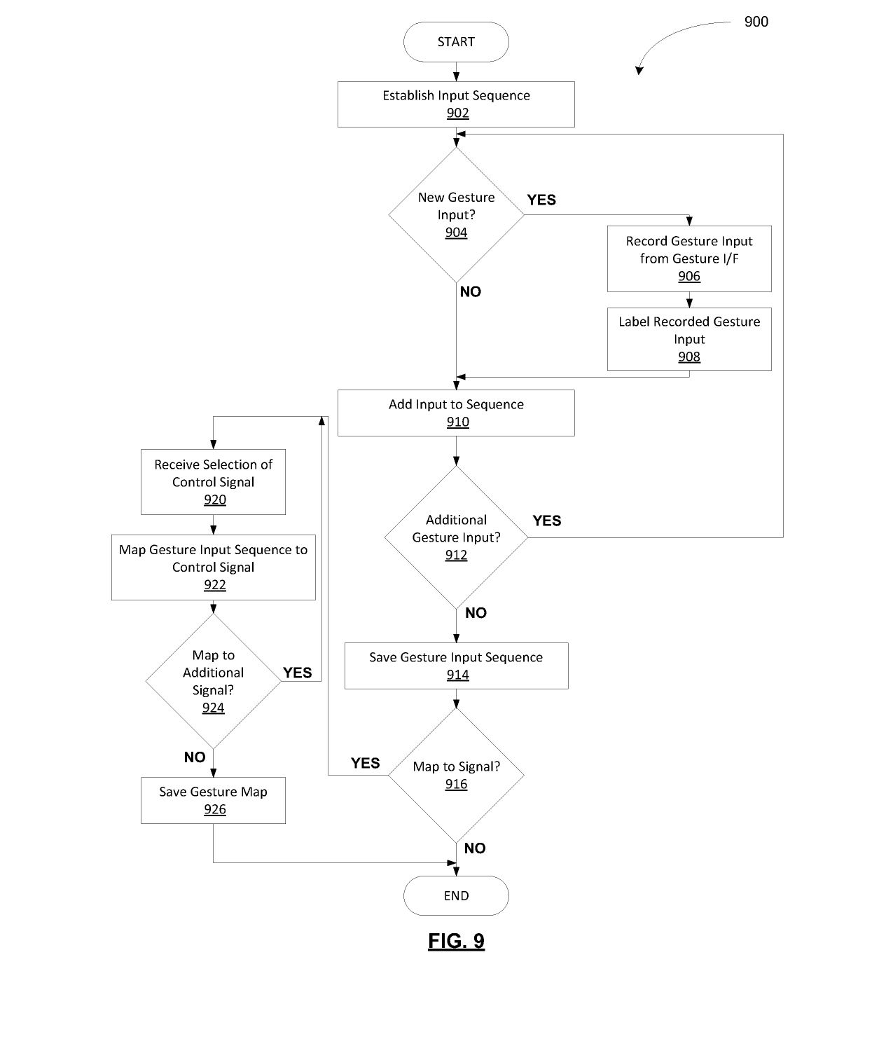

FIG. 9 is a diagram illustrating a process 900 that can include establishing one or more gesture input signals, associating various gesture input signals with a gesture input sequence, and mapping one or more gesture input signals to one or more control signals. In some embodiments, process 900 is supported, at least in part, by a processing system, processing circuitry, service, or application without any user input. Process 900 can also be supported by interactions between a user and a device supporting the user.

As shown in block 902, process 900 can include establishing a gesture input sequence. A gesture input sequence can include a single gesture input signal or a plurality of associated gesture input signals. As shown in blocks 904-912, process 900 can include associating various gesture input signals with the established gesture input sequence. As shown in block 904, process 900 can include determining whether a gesture input signal to be associated with the gesture input sequence is a predefined gesture input signal. If so, the predefined gesture input signal can be selected and associated with the sequence, as shown in block 910. If not, as shown in blocks 906-908, a new gesture input signal can be established by recording a gesture input captured by a gesture input interface and identifying the recorded gesture input as a gesture input signal. The gesture input signal via which a gesture input is capture can be selected, and a recording of the gesture input can be managed via user interaction with an interface, via some internal logic, or the like. For example, a user may interact with a user interface to start recording by one or more gesture input interfaces, perform a gesture to be captured as gesture input by the gesture input interface, and interact with the user interface to stop recording. In another example, recording of a gesture input can be stopped upon the elapse of a period of time since recording is begun, upon the elapse of a period of time since a gesture input was last capture by the gesture input interface, or some combination thereof. Labeling of a recorded gesture input can be accomplished via user input, automatically, etc.

As shown in block 910, process 900 can include associating a selected gesture input signal with a gesture input sequence. Addition can be in response to an interaction between a user and an input interface, based upon association of one or more gesture input signals, some internal logic, etc. As shown in block 912, process 900 can include determining whether to associate an additional gesture input signal with the gesture input sequence. If not, as shown in block 914, the gesture input sequence can be saved into a memory. The gesture input sequence can be associated with one or more particular accounts, devices, or some combination thereof. The gesture input sequence can include various associations of gesture input signals. For example, various gesture input signals can be associated in a gesture input sequence such that the gesture input sequence is identified where the gesture input signals are identified in a certain order, simultaneously, or some combination thereof.

As shown in block 916, process 900 can include determining whether to map a saved gesture input sequence to one or more control signals. If so, as shown in block 920, process 900 can include receiving a selection one or more control signals. A control signal can be selected by a user interacting with a representation of one or more control signals on an interface. A control signal can also be selected according to some internal logic. As shown in block 922, process 900 can include mapping the saved gesture input sequence to the selected one or more control signals. Mapping can include establishing an association between the gesture input sequence and the one or more control signals. Process 900 can include, as shown in block 924, determining whether to map the gesture input sequence to an additional control signal. If so, blocks 920-922 can be repeated. Where multiple control signals are selected to for mapping by a gesture input sequence, the control signals can be associated as a control signal sequence. The control signals in the control signal sequence can be associated such that the gesture input sequence is associated with the control signal sequence. In addition, various control signals can be associated in a control signal sequence such that, where a control signal sequence is performed in response to identification of the associated gesture input sequence, the control signals in the control signal sequence are sent in a certain order, simultaneously, or some combination thereof.

Process 900 can include, as shown in block 926, responding to a determination that the gesture input sequence is not to be mapped to an additional control signal by saving the association of the gesture sequence and the one or more control signals as a gesture map. In some embodiments, an association of a gesture input sequence and a control signal sequence is saved as a macrosequence. A gesture map or macrosequence can be associated with one or more various accounts or devices. For example, where process 900 is performed, at least in part, by a device, a gesture map can be associated with an account that is itself associated with the device, an account associated with a user supported by the device, or some combination thereof. In another example, where process 900 is performed, at least in part, by a control device supporting at least some part of a media environment, a gesture map can be associated with an account that is itself associated with one or more selected input devices, users, or the like.

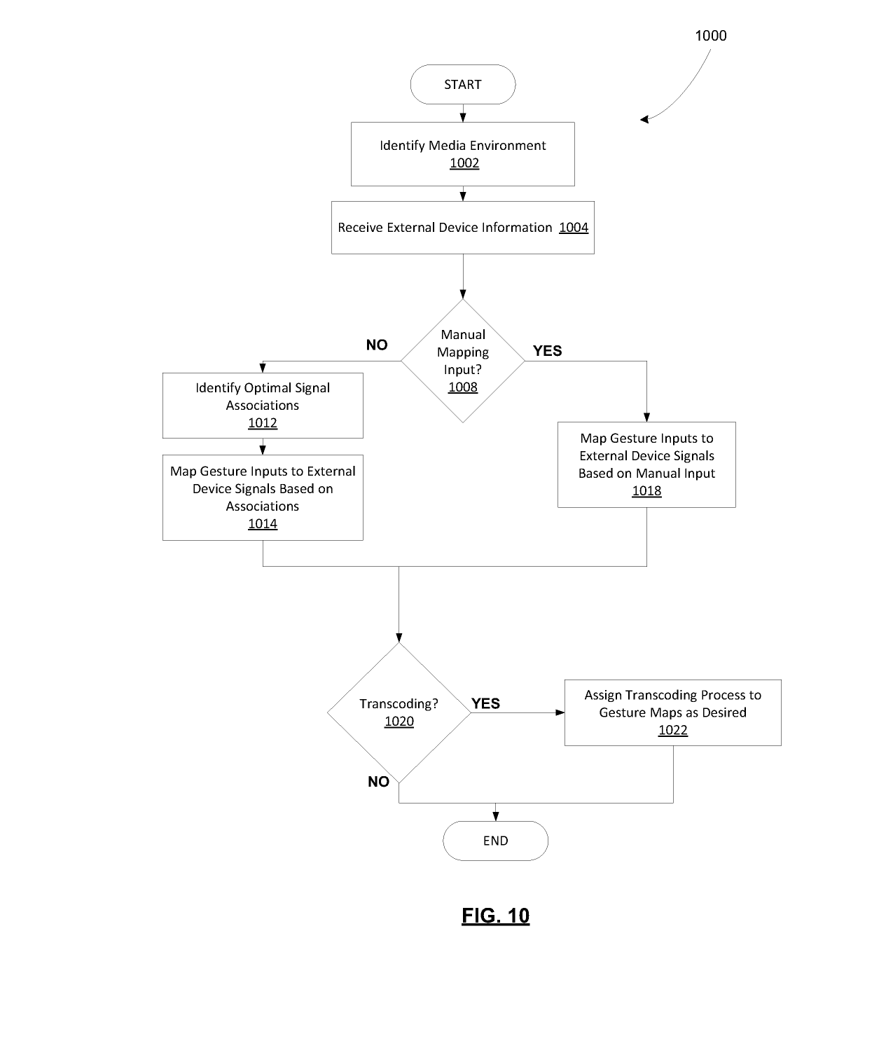

FIG. 10 is a diagram illustrating a process 1000 that can include mapping one or more gesture input signals to one or more control signals received from an external source. In some embodiments, process 1000 is supported by a device as part of interactions with a media environment. As shown in block 1002, process 1000 can include identifying a media environment. Identification of a media environment can include, without limitation, receiving a signal from some part of the media environment, and identifying the media environment based upon the signal. As shown in block 1004, process 1000 can include receiving information associated with an external device. The external device can be part of the media environment identified in block 1002. In some embodiments, the information is pulled from some part of the media environment in response to identifying the media environment. For example, where a device identifies a media environment that includes an external device, the device can respond to the identification by interacting with some part of the media environment to receive information related to at least some part of the media environment, including, without limitation, the external device. The device can interact directly with the external device, with another device, service, or application associated with the media environment. Information associated with an external device can include, without limitation, configuration information associated with the external device. Configuration information associated with the external device can include control signals that control some aspect of the external device. Receiving the information can include accessing the information from another device, service, or application, requesting the information, or the like.

As shown in blocks 1008-1018, process 1000 can include mapping one or more gesture input signals to one or more signals associated with the external device (an “external device signal”). Signals associated with the external device can include control signals that control some aspect of the external device. As shown in block 1008, process 1000 can include determining whether a mapping of a gesture input signal to an external device signal is to be based, at least in part, on manual input received from a user. If so, as shown in block 1018, process 1000 can include mapping one or more gesture inputs to one or more external device signals based upon manual input received from the user. Manual input can be received based upon an interaction between the user and a user interface. The gesture input signal that is mapped to an external device signal can include one or more gesture input signals selected from one or more sets of predefined gesture input signals, gesture input signals associated with an account, gesture input signals associated with some part of a media environment, or some combination thereof. In addition, the one or more external device signals to which one or more gesture input signals are mapped can be selected from one or more sets of external device signals, control signals, signals associated with at least some part of a media environment, signals associated with at least some part of a device, or some combination thereof. In some embodiments, mapping a gesture input signal to an external device signal includes associating the gesture input signal with the external device signal, such that a gesture processing framework can respond to identifying the gesture input signal by sending the external device signal. In some embodiments, mapping one or more gesture input signals to one or more external device signals includes establishing a gesture map that includes the association of the one or more gesture input signals with the one or more external device signals.

As shown in blocks 1012-1014, process 1000 can include mapping one or more gesture input signals to one or more external device signals where no manual mapping input is received, as determined in block 1008. As shown in block 1012, process 1000 can include identifying an optimal association of one or more gesture input signals and external device signals. An optimal association can be determined from historical mappings of various gesture input signals and external device signals, suggested mappings, or some combination thereof. As shown in block 1014, process 1000 can include mapping one or more gesture input signals to one or more external device signals. Such mapping can be based, at least in part, upon one or more optimal signal associations identified in block 1014. Such mapping can also include establishing one or more gesture maps.

As shown in blocks 1020-1022, process 1000 can include assigning a transcoding process to a gesture map, where such process is desired. In some embodiments, transcoding of one or more gesture input signals or external device signals may be determined to be desirable based upon security of communications between various devices, services, applications, and networks.

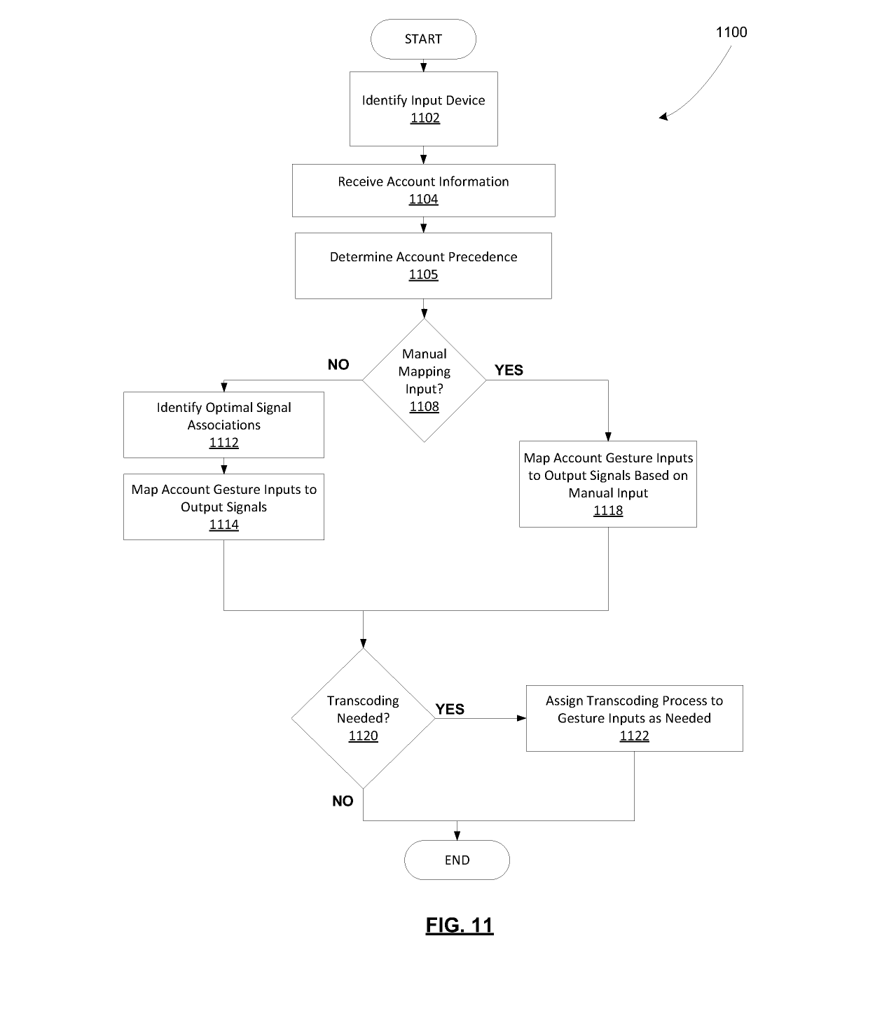

FIG. 11 is a diagram illustrating a process 1100 that can include mapping one or more gesture input signals to one or more control signals received from an external source. In some embodiments, process 1100 is supported by a device as part of interactions with a media environment. As shown in block 1102, process 1100 can include identifying an input device. Identification of an input device can include, without limitation, receiving a signal from some part of the input device, and identifying the input device based upon the signal.

As shown in block 1104, process 1100 can include receiving account information. The account information can include information associated with an account that is itself associated with the input device, a user supported by the input device, or some combination thereof. Account information can include, without limitation, saved gesture input signals, gesture maps, and device information. In some embodiments, the account information is pulled from some part of an input device in response to identifying the input device. For example, where a device identifies an input device, the device can respond to the identification by interacting with some part of the input device to receive account information associated with an account that is itself associated with the input device. Account information can include, without limitation, configuration information associated with the input device. Receiving the account information can include accessing the account information from another device, service, or application, requesting the information, or the like.

As shown in block 1105, process 1100 can include determining the precedence of an account that is itself associated with the input device, a user supported by the input device, some combination thereof, or the like. In some embodiments, precedence is determined by processing precedence information included in the account information. Precedence of an account can be determined to prioritize input signals received from input devices that have higher precedence than other input devices, prioritize input signals received from input devices supporting users that have higher precedence than input signals received from input devices supporting users that have lower precedence, and the like.

As shown in blocks 1108-1118, process 1100 can include mapping one or more gesture input signals to one or more output signals. Output signals can include control signals that control some aspect of a media environment. As shown in block 1108, process 1100 can include determining whether a mapping of a gesture input signal to an output signal is to be based, at least in part, on manual input received from a user. If so, as shown in block 1118, process 1100 can include mapping one or more gesture inputs to one or more output signals based upon manual input received from the user. Manual input can be received based upon an interaction between the user and a user interface. The gesture input signal that is mapped to an output signal can include one or more gesture input signals selected from one or more sets of predefined gesture input signals, gesture input signals associated with an account, gesture input signals associated with some part of a media environment, some combination thereof, or the like. In some embodiments, mapping a gesture input signal to an output signal includes associating the gesture input signal with the output signal, such that a gesture processing framework can respond to identifying the gesture input signal by sending the output signal. In some embodiments, mapping one or more gesture input signals to one or more output signals includes establishing a gesture map that includes the association of the one or more gesture input signals with the one or more output signals.

As shown in blocks 1112-1114, process 1100 can include mapping one or more gesture input signals to one or more output signals where no manual mapping input is received, as determined in block 1108. As shown in block 1112, process 1100 can include identifying an optimal association of one or more gesture input signals and output signals. An optimal association can be determined from historical mappings of various gesture input signals and output signals, suggested mappings, some combination thereof, or the like. As shown in block 1114, process 1100 can include mapping one or more gesture input signals to one or more output signals. Such mapping can be based, at least in part, upon one or more optimal signal associations identified in block 1114. Such mapping can also include establishing one or more gesture maps.

As shown in blocks 1120-1122, process 1100 can include assigning a transcoding process to a gesture map, where such process is desired. In some embodiments, transcoding of one or more gesture input signals, output signals, or the like may be determined to be desirable based upon security of communications between various devices, services, applications, networks, and the like.

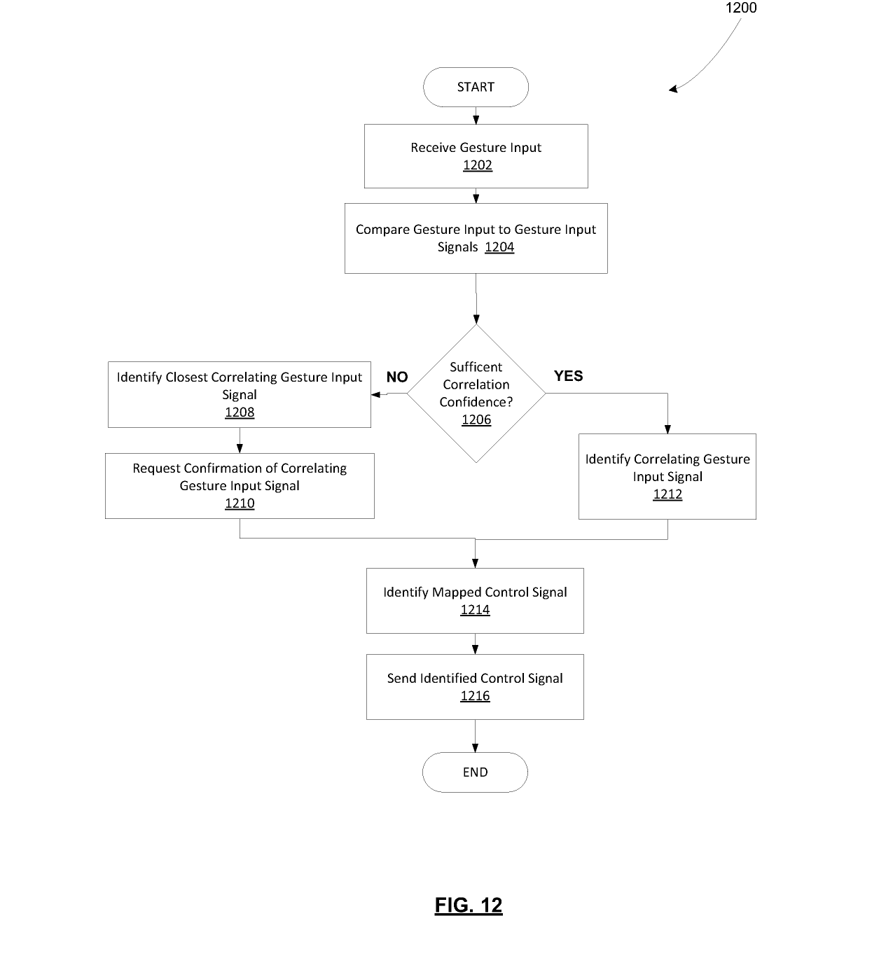

FIG. 12 is a diagram illustrating a process 1200 that can include responding to identification of a gesture input signal by sending a control signal to which the identified gesture input signal is mapped. In some embodiments, process 1200 is supported by a device as part of interactions with a media environment, some part of a media environment, a service, application, or the like.

As shown by block 1202, process 1200 can include receiving a gesture input. A gesture input can be received via a linked gesture input interface, a coupled input device, a communication network, some combination thereof, or the like. A gesture input can include gesture information generated, at least in part, by a gesture input interface that captures a corresponding gesture performed by a user. For example, where a gesture input interface captures visual gestures, the gesture input interface can capture a visual gesture made by a user and generate gesture information as a gesture input. The gesture input can be received from one or more gesture input interfaces and processed to identify the gesture input as a gesture input signal.

As shown in block 1204, process 1200 can include comparing a gesture input with one or more gesture input signals. By comparing a gesture input, which can include, without limitation, the gesture input received in block 1202, with gesture input signals, the gesture input can be identified as a certain gesture input signal. Gesture signals against which a gesture input can be compared can include, without limitation, one or more sets of predefined gesture input signals, one or more sets of saved gesture input signals associated with one or more accounts, devices, users supported by some part of a device, media environment, network, service, application, some combination thereof, or the like.

As shown in blocks 1206-1212, process 1200 can include determining whether a gesture input correlates to one or more gesture input signals to within a certain level of confidence. As shown in block 1212, where a gesture input and a gesture input signal are determined to have a sufficient level of correlation, process 1200 can include identifying the gesture input as the gesture input signal. For example, a gesture input that has a correlation confidence of 90% (i.e., 90% correlation) with a gesture input signal can be identified as the gesture input signal. Such identification can include a determination that the identified gesture input signal has been received.

As shown in blocks 1208-1210, where a gesture input is determined to not correlate within one or more correlation confidence levels, the gesture input can be identified as one or more gesture input signals via manual input. For example, as shown in block 1208, process 1200 can include identifying various gesture input signals to which the gesture input correlates most closely. For example, where a gesture input does not correlate with any known gesture input signal to within a predefined 90% required confidence level, but correlates by 80% to a first gesture input signal and by 75% to a second gesture input signal, the gesture input can be determined to potentially include one or more of the first and second gesture input signals. As shown in block 1210, process 1200 can include confirming the identity of the gesture input as a certain one or more gesture input signals by requesting confirmation of the gesture input signals. For example, in continuation of the above example, representations of the first and second gesture input signals can be presented to a user, via a user interface, and the user can be invited to confirm which of the two gesture input signals, if any, the gesture input is intended to correlate. The user can select one or more of the gesture input signals, select another gesture input signal, dismiss the gesture input, or the like.

As shown in block 1214, process 1200 can include identifying one or more control signals to which an identified gesture input signal is mapped. In some embodiments, such control signals are identified via an association between the identified one or more gesture input signals and the one or more control signals, which can be part of a gesture map, control signal map, or the like. A control signal can be associated with a gesture input signal via common association with another control signal. For example, a gesture input signal can be mapped to a first control signal, and the first control signal can be associated with a second control signal, such that process 1200 can include responding to identification of the gesture input signal by identifying the second control signal. As shown in block 1216, process 120 can include sending an identified control signal.

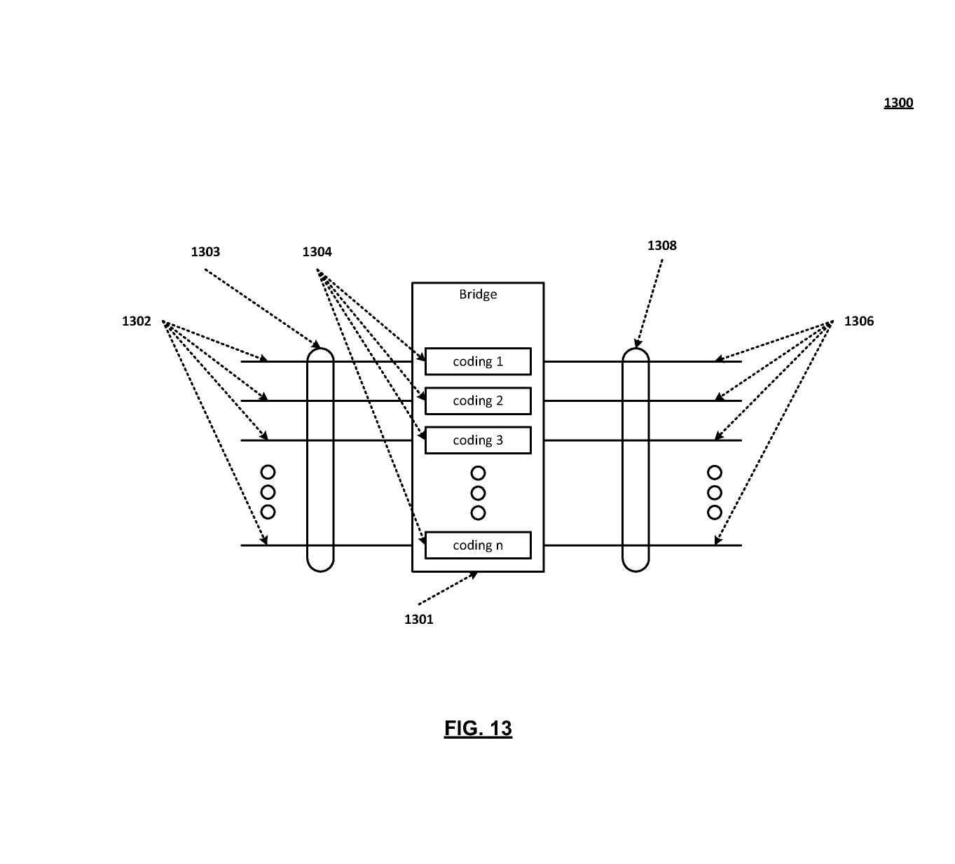

Referring to the embodiment 1300 of FIG. 13, multiple respective input signals 1302 are received by bridge 1301. These respective input signals 1302 can include gesture input signals, gesture inputs received from one or more gesture input interfaces, control signals, some combination thereof, or the like. Input signals may be received separately or combined in some manner (e.g., partially combined such that only certain of the input signals 1302 are included in one or more groups, fully combined, etc.). Also, it is noted that the respective input signals 1302 need not necessarily be received synchronously. That is to say, a first respective input signal 1302 may be received 1303 at or during a first time, a second respective input signal 1302 may be received at or during a second time, etc.

The bridge 1301, in some embodiments, is operative to employ any one of a number of respective codings 1304 to the respective input signals 1302 received 1303 thereby. That is to say, the bridge 1301 is operative selectively to encode each respective input signal 1302. For example, any of a number of tools may be employed for selectively encoding 1308 a given input signal 1302, including, but not limited to, a manual command received via a user interface, one or more mappings of input signals to control signals, internal logic, or the like. The bridge may select any combination of such respective tools for encoding 1308 a given input signal 1302. The encoded/transcoded output signals 1306 may be output from the bridge 1301 in an unbundled or decoupled format for independent wireless transmission to one or more other devices.

Any of a number of encoding selection parameters may drive the selective combination of one or more respective tools as may be employed for encoding 1308 a given signal. For example, some encoding selection parameters may include signal type, the content of the signal, one or more characteristics of a wireless communication channel by which the encoded/transcoded signals 1306 may be transmitted, the proximity of the bridge 1301 or a device including the bridge 1301 to one or more other devices to which the encoded/transcoded signals 1306 may be transmitted, the relative or absolute priority of one or more of the encoded/transcoded signals 1306, sink characteristics channel allocation of one or more wireless communication channels, quality of service, characteristics associated with one or more intended recipients to which the encoded/transcoded signals 1306 may be transmitted, etc.).

As can be seen with respect to this diagram, a single bridge 1301 includes selectivity by which different respective signals 1302 may be encoded/transcoded 1308 for generating different respective encoded/transcoded signals 1306 that may be independently transmitted to one or more output devices for consumption by one or more users.

In some embodiments, one or more codings in bridge 1301 are one or more encoders operating cooperatively or in a coordinated manner such that different respective signals 1302 may be selectively provided to one or more of the encoders. As the reader will understand, such an embodiment can include separate and distinctly implemented encoders that are cooperatively operative to effectuate the selective encoding/transcoding 1308 of signals 1302 as compared to a single bridge 1301 that is operative to perform encoding/transcoding 1308 based upon one or more codings 1304. In accordance with one implementation of the architecture of this particular diagram, each respective encoder 1304 in the bridge 1301 may correspond to a respective coding.

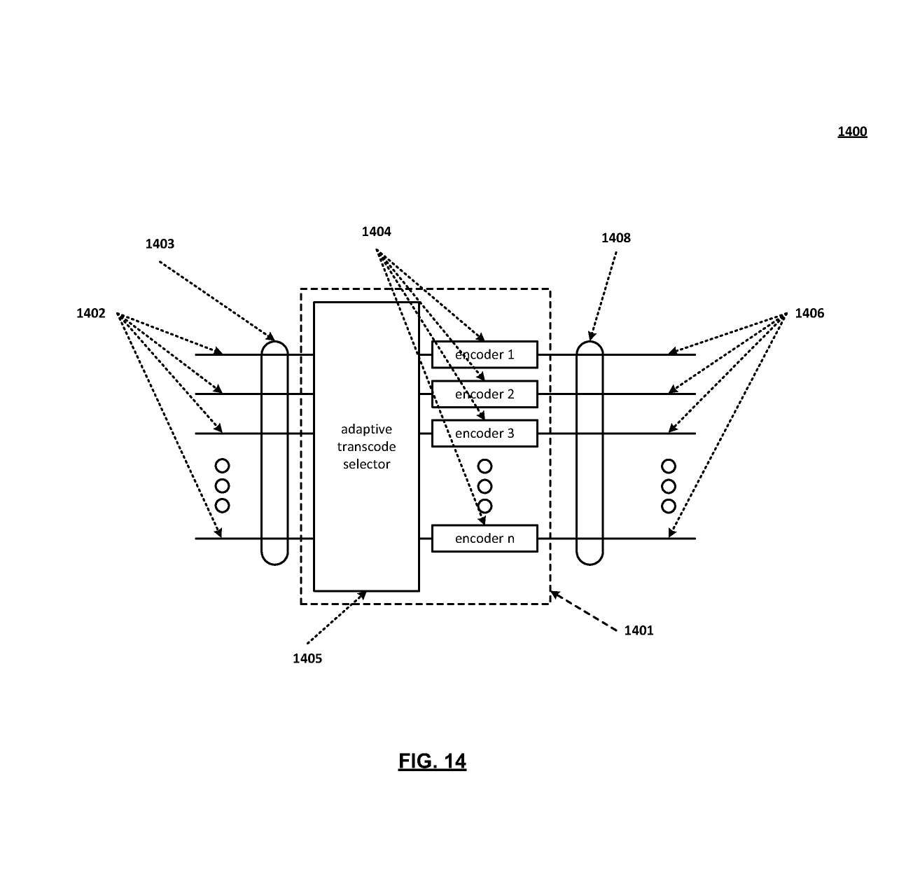

Referring to the embodiment 1400 of FIG. 14, this diagram depicts yet another embodiment 1400 that is operable to effectuate selectivity by which different received 1403 respective input signals 1402 may be encoded/transcoded 1408 for generating different respective encoded/transcoded control signals 1406 that may be independently transmitted to one or more output devices for consumption by one or more users.

As can be seen with respect to this embodiment, bridge 1401 includes an adaptive transcode selector 1405 that is operative to provide respective 1402 to one or more encoders 1404. In accordance with one implementation of the architecture of this particular diagram, each respective encoder 1404 in the bridge 1401 may correspond to a respective coding. The adaptive transcode selector 1405 is the circuitry, module, etc. that is operative to perform the selective providing of the respective signals 1402 to one or more encoders 1404.

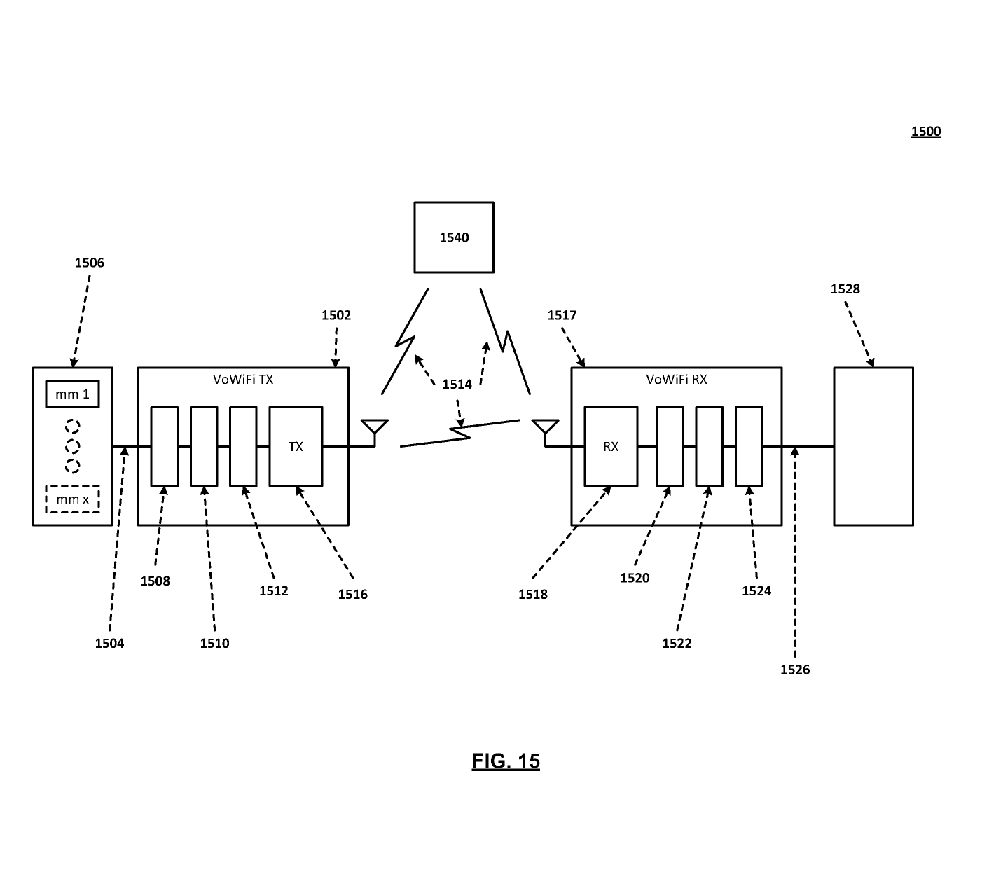

FIG. 15 is a diagram illustrating an embodiment 1500 of a wireless communication system. The wireless communication system of this diagram illustrates how different respective signals may be bridged between one or more input devices 1506 to one or more output devices 1528 (e.g., examples of such devices include, but are not limited to, STBs, Blu-Ray players, PCs {personal computers}, etc.). A video over wireless local area network/Wi-Fi transmitter (VoWiFi TX) 1502 is operative to receive one or more signals 1504 from one or more input devices 1506. These one or more signals 1504 may be provided in accordance with any of a variety of communication standards, protocols, and/or recommended practices. In one embodiment, one or more signals 1504 are provided in accordance with High Definition Multi-media Interface™ (HDMI) and/or YUV (such as HDMI/YUV). As the reader will understand, the YUV model defines a color space in terms of one luma (Y) [e.g., brightness] and two chrominance (UV) [e.g., color] components.

The VoWiFi TX 1502 includes respective circuitries and/or functional blocks therein. For example, an HDMI capture receiver initially receives the one or more signals 1504 and performs appropriate receive processing 1508 thereof. An encoder 1510 then is operative selectively to encode different respective signals in accordance with the in accordance with various aspects, and their equivalents, of the invention. A packetizer 1512 is implemented to packetize the respective encoded/transcoded signals 1514 for subsequent transmission to one or more output devices 1516, using the transmitter (TX) 1516 within the VoWiFi TX 1502.

Independent and unbundled encoded/transcoded signals 1514 may be transmitted to one or more output devices 1517 via one or more wireless communication channels. Within this diagram, one such output device 1517 is depicted therein, namely, a video over wireless local area network/Wi-Fi receiver (VoWiFi RX) 1517. Generally speaking, the VoWiFi RX 1516 is operative to perform the complementary processing that has been performed within the VoWiFi TX 1502. That is to say, the VoWiFi RX 1517 includes respective circuitries and/or functional blocks that are complementary to the respective circuitries and/or functional blocks within the VoWiFi TX 1502. For example, a receiver (RX) 1518 therein is operative to perform appropriate receive processing of one or more signals 1514 received thereby. A de-packetizer 1520 is operative to construct a signal sequence from a number of packets. Thereafter, a decoder 1522 is operative to perform the complementary processing to that which was performed by the encoder within the VoWiFi TX 1502. The output from the decoder is provided to a render/HDMI transmitter (TX) 1524 to generate at least one encoded/transcoded signal 1526 that may be output via one or more output devices 1528 for consumption by one or more users.

In some embodiments, a bridge 1540 may include both an input device 1502 and an output device 1517, such that the bridge 340 can receive and process transcoded signals transmitted 1514 over a first network and re-process and transcode the signals for transmission 1514 over another network. For example, the bridge 1540 can, in some embodiments, receive wired signals 1504 in the form of transcoded wireless signals 1514, process the signals using respective circuitries 1520, 1522, 1524, 1508, 1510, and 1512, and transmit the re-transcoded signal 1514 to an output device 1517 to be processed back into a wired signal 1526. The bridge 1540 can, in some embodiments, enable an input device 1506 to stream a video stream over a wireless network (VoWiFi) to a video output device 1528 that normally receives input via a wired connection. For example, a video stream received at a touchscreen input device from a network can be transcoded into a wireless signal that is transmitted 1514 from VoWiFI TX 1502, with or without a bridge 1540, to a VoWiFi RX 1517, to be transcoded to a wired HDMI signal 1526 to be displayed on an HDMI television output device 1528.

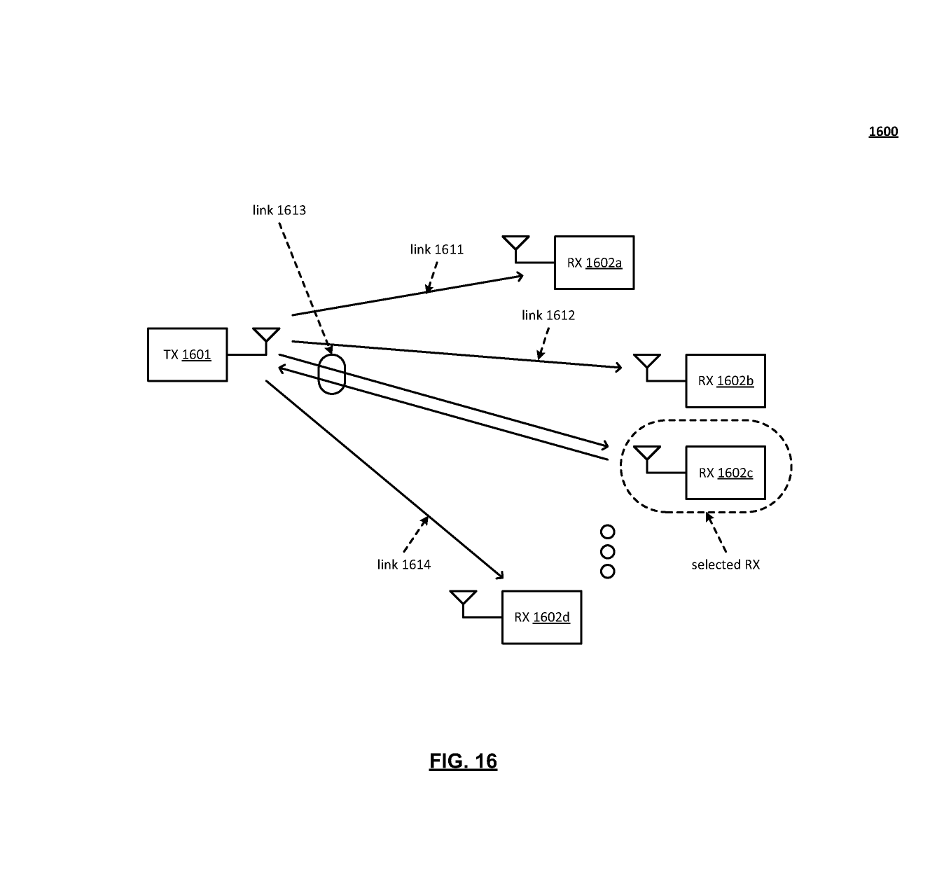

FIG. 16 is a diagram illustrating an embodiment 1600 of supporting communications from a transmitter wireless communication device to a number of receiver wireless communication devices based on bi-directional communications (e.g., management, adaptation, control, acknowledgements (ACKs), etc.) with a selected one of the receiver wireless communication devices. In some embodiments, the illustrated embodiment 1600 of supporting communications can be utilized by a device to communicate with various media devices in a media environment to acquire configuration information, or the like. With respect to this diagram, it can be seen that communications between a transmitter wireless communication device 1601 and non-selected receiver wireless communication devices 1602a, 1602b, and 1602d are all effectuated in a unidirectional manner via links 1611, 1612, and 1614. However, communications between transmitter wireless communication device 1601 and receiver wireless communication device 1602c (e.g., a selected receiver wireless communication device) are effectuated in a bidirectional manner via link 1613. For example, any of a number of communications from receiver wireless to communication device 1602c may be provided to the transmitter wireless communication device 1601 via link 1613. Some examples of such upstream communications may include feedback, acknowledgments, channel estimation information, channel characterization information, and/or any other types of communications that may be provided for assistance, at least in part, for the transmitter wireless communication device 1601 to determine and/or select one or more operational parameters by which communications are effectuated there from to the receiver wireless communication devices 1602a-1602b.

As may be understood with respect to the diagram, the unidirectional communications with the non-selected receiver wireless communication devices 1402a-802d are based upon one or more operational parameters associated with the selected receiver wireless communication device 1402c. Within this embodiment and also within various other embodiments included herein, it may be seen that communications from a given transmitter wireless communication device are effectuated in accordance with adaptation and control that is based upon one particular and selected communication link within the wireless communication system. The other respective wireless communication links within the wireless communication system do not specifically govern the one or more operational parameters by which communications are effectuated, yet the respective receiver wireless communication devices associated with those other respective wireless communication links may nonetheless receive and process communications from the transmitter wireless communication device.

In the context of communications including video information (e.g., streaming video), any of the respective receiver wireless communication devices is then operative to receive such video information from such a transmitter wireless communication device. However, again, it is the communication link between the transmitter wireless communication device and the selected receiver wireless communication device that is employed to determine and/or select the one or more operational parameters by which such video information is communicated to all of the receiver wireless communication devices.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. An image-based gesture processing system supporting a first user device of a first user and a media device, the media device being controllable via a media control standard, the system comprising:
a storage element operable to store personalized gesture data of the first user, the personalized gesture data of the first user including a plurality of gesture inputs and a plurality of commands, each of the plurality of gesture inputs is associated with at least one of the plurality of commands;
a sensing element operable to capture image data associated with a visual gesture motion of the first user as gesture information;
an analysis element operable to process the gesture information to identify at least one visual gesture;
a recognition element operable to process the at least one visual gesture, using the personalized gesture data of the first user, to recognize a first gesture input of the plurality of gesture inputs;
a command element operable to process the first gesture input to identify a first command of the plurality of commands, the first command is associated with the first gesture input; and
an output element operable to send the first command to the media device via the media control standard.

2. The image-based gesture processing system of claim 1, comprising:
the storage element operable to store personalized gesture data of a second user, the personalized gesture data of the second user including a second plurality of gesture inputs and a second plurality of commands, the personalized gesture data of the second user is separate from the personalized gesture data of the first user;
the analysis element operable to process the gesture information to identify at least one visual gesture, the at least one visual gesture is associated with the second user;
the recognition element operable to respond to an identification of an association of the at least one visual gesture with the second user by processing the at least one visual gesture, using the personalized gesture data of the second user, to recognize a first gesture input of the second plurality of gesture inputs; and
the command element operable to process the first gesture input of the second plurality of gesture inputs to identify a first command of the second plurality of commands, the first command of the second plurality of commands is associated with the first gesture input of the second plurality of gesture inputs.

3. The image-based gesture processing system of claim 1 comprising a mapping element operable to support creation of personalized gesture data of the first user by:
establishing a personalized sequence of visual gestures as at least one gesture input; and
associating the at least one gesture input with a personalized sequence of at least one command.

4. A device that supports interactions with a first user and a plurality of communications devices, the plurality of communications devices including a local device and a foreign device, the device comprising:
an interface that communicatively couples with at least the plurality of communication devices;
a memory that stores a first personalized gesture data including an association of a first gesture input with a local command associated with a local function of the local device; and
processing circuitry interoperable with the interface and the memory to:
access a foreign command associated with a foreign function of the foreign device, and
respond to a determination that the foreign function correlates with the local function by establishing a second personalized gesture data including an association between at least the first gesture input and the foreign command.

5. The device of claim 4, the processing circuitry interoperable with the interface and the memory to respond to identification of image data captured by at least one sensing element as at least the first gesture input by sending a command associated with both the first gesture input and a detected device.

6. The device of claim 4, the processing circuitry interoperable with the interface and the memory to provide at least the second personalized gesture data to a support device to process image data captured by at least one sensing element to identify the first gesture input.

7. The device of claim 6, the device comprising a sensing element that captures visual gesture motions as image data, the processing circuitry interoperable with the sensing element, interface and the memory to send the image data to the support device to process the identify the image data as the first gesture input.

8. The device of claim 5, wherein:
the support device is a remote processing system to which the device is communicatively coupled;
the processing circuitry interoperable with the interface and the memory to:
provide image data captured by at least one sensing element to the remote processing system to be identified as the first gesture input, and
in response to the providing, access the first gesture input from the remote processing system.

9. The device of claim 5, the processing circuitry interoperable with the interface and the memory to interact with the sensing element to characterize a property of the image data.

10. The device of claim 5, identifying at least the first gesture input includes determining that the image data correlates with a stored instance of the first gesture input.

11. The device of claim 10, wherein:
identifying at least the first gesture input further includes determining that the image data correlates with the stored instance of the first gesture input to within a certain level of confidence; and
the processing circuitry interoperable with the interface to respond to determining that the image data fails to correlate with the stored instance of the first gesture input to within a certain level of confidence by requesting input to identify the first gesture input.

12. The device of claim 4, the local command is different than the foreign command.

13. A visual gesture processing system supporting interactions involving a local media environment and a foreign device, the local media environment including a plurality of controllable media devices, the system comprising:
a first system operable to support accessing personalized gesture data from the foreign device, the personalized gesture data including a first personalized association of an input set of at least one gesture input with a first command set of at least one foreign command, the input set corresponds to the first command set; and
the first system operable to support responding to a determination that the foreign command correlates to at least one distinct local command associated with at least one media device of the plurality of media devices by mapping the personalized gesture data to the at least one media device to establish a second personalized association of the input set to a second command set with the at least one distinct local command.

14. The visual gesture processing system of claim 13, the first system operable to support responding to identifying visual gesture motion information captured by a sensing element as the at least one gesture input by delivering the distinct local command to the at least one media device.

15. The visual gesture processing system of claim 14, the identifying involving comparing the visual gesture motion information with personalized gesture data associated with the sensing element.

16. The visual gesture processing system of claim 13, comprising:
the first system operable to support accessing a plurality of individual visual gesture motion information captured by a plurality of sensing elements, each of the plurality of individual visual gesture motion information is associated with one of a plurality of users; and
the first system operable to support processing each individual visual gesture motion information to identify at least one gesture input based on an associated personalized gesture data.

17. The visual gesture processing system of claim 13, the first system operable to support creation of personalized gesture data associated with one of a plurality of users by:
establishing a personalized sequence of gesture inputs as at least one input set; and
associating the at least one gesture input with a personalized sequence of at least one command.

18. The visual gesture processing system of claim 17, each of the personalized sequence of gesture inputs and the personalized sequence of at least one command are selected, at least in part, via input from the one of the plurality of users.

19. The visual gesture processing system of claim 14, identifying the at least one gesture input includes determining that the visual gesture motion information correlates with a stored instance of the at least one gesture input.

20. The visual gesture processing system of claim 19, wherein:
identifying the at least one gesture input further includes determining that the visual gesture motion information correlates with the stored instance of the at least one gesture input to within a predefined level of confidence; and
the first system operable to support responds to a determination that the visual gesture motion information fails to correlate with the stored instance of the at least one gesture input to within a certain level of confidence by requesting input to identify the at least one gesture input.
